(19) United States
(12) Patent Application Publication
(10) Pub. No.: US 2025/0117717 A1
(43) Pub. Date: Apr. 10, 2025

(54) Vehicle Request Coordination System for Multi-Client Computing Ecosystem

(71) Applicant: Joby Aero, Inc., Santa Cruz, CA (US)

(72) Inventors: Kellen Christopher Mollahan, Summit, NJ (US); Karl Weston Schulz, Long Island City, NY (US); Matthew David Schwegler, San Francisco, CA (US)

(21) Appl. No.: 18/907,029

(22) Filed: Oct. 4, 2024

Related U.S. Application Data
(60) Provisional application No. 63/587,851, filed on Oct. 4, 2023.

(51) Int. Cl. G06Q 10/02; G06Q 50/47

(52) U.S. Cl. CPC G06Q 10/025; G06Q 50/47

(57) ABSTRACT

Example aspects of the present disclosure provide for an example method. The example method can include accessing a first request for providing transportation along a first multi-leg transportation journey and a second request for providing transportation along a second multi-leg transportation journey. The example method can include querying a vehicle slot register to access data descriptive of unallocated vehicle slots for providing transportation services. The example method can include computing, using a request arbitration model, a first allocation for servicing the first request and a second allocation for servicing the second request. The example method can include updating the vehicle slot register based on the first allocation and the second allocation. The example method can include outputting a first response for the first request indicating the first allocation. The example method can include outputting a second response for the second request indicating the second allocation.

### PRIORITY

The present application claims priority to U.S. Provisional Patent Application No. 63/587,851, which was filed Oct. 4, 2023, and which is hereby incorporated by reference herein in its entirety.

### FIELD

The present disclosure relates generally to deconflicting queries within a distributed computing ecosystem. In particular, the present disclosure includes computationally efficient processes for deconflicting resource requests within a distributed computing ecosystem for providing multimodal transportation services.

### BACKGROUND

Transportation service applications allow individual users to request transportation. For example, service providers can match drivers/vehicles to requests for transporting a rider to a requested destination or delivering packages, goods, or prepared foods. Computing platforms can be used to help facilitate these services.

### SUMMARY

Aspects and advantages of implementations of the present disclosure will be set forth in part in the following description, or may be learned from the description, or may be learned through practice of the implementations.

Example aspects of the present disclosure provide for an example method. The example method can include accessing a first request for providing transportation along a first multi-leg transportation journey and a second request for providing transportation along a second multi-leg transportation journey. The example method can include querying a vehicle slot register to access data descriptive of unallocated vehicle slots for providing transportation services. The example method can include computing, using a request arbitration model, a first allocation for servicing the first request and a second allocation for servicing the second request. The example method can include updating the vehicle slot register based on the first allocation and the second allocation. The example method can include outputting a first response for the first request indicating the first allocation. The example method can include outputting a second response for the second request indicating the second allocation.

Example aspects of the present disclosure provide for one or more non-transitory computer-readable media storing instructions that are executable by one or more processors to perform operations, the operations including the example method.

Example aspects of the present disclosure provide for a computing system that includes one or more processors and the example one or more non-transitory computer-readable media.

Other example aspects of the present disclosure are directed to other systems, methods, vehicles, apparatuses, tangible non-transitory computer-readable media, and devices for a vehicle request coordination system for a multi-client service environment.

These and other features, aspects and advantages of various implementations will become better understood with reference to the following description and appended claims. The accompanying drawings, which are incorporated in and constitute a part of this specification, illustrate implementations of the present disclosure and, together with the description, serve to explain the related principles.

### BRIEF DESCRIPTION OF THE DRAWINGS

Detailed discussion of implementations directed to one of ordinary skill in the art are set forth in the specification, which makes reference to the appended figures, in which:

FIG. 1 depicts an example journey of a multimodal transportation service according to example implementations of the present disclosure;

FIG. 2 depicts a networked ecosystem of example computing systems for providing a multimodal transportation service according to example implementations of the present disclosure;

FIG. 3A depicts an example device register for organizing resources associated with example computing systems for providing a multimodal transportation service according to example implementations of the present disclosure;

FIG. 3B depicts an example service instance register for allocating resources associated with example computing systems for providing a multimodal transportation service according to example implementations of the present disclosure;

FIG. 3C depicts an example data structure for allocating resources associated with example computing systems for providing a multimodal transportation service according to example implementations of the present disclosure;

FIG. 4 depicts example computing systems for providing an example multimodal transportation service according to example implementations of the present disclosure;

FIG. 5A depicts an example system for coordinating vehicle requests from multiple client systems for providing a multimodal transportation service according to example implementations of the present disclosure;

FIG. 5B depicts an example computing architecture of the system for coordinating vehicle requests from multiple client systems according to example implementations of the present disclosure;

FIG. 6A depicts an example flow diagram for providing an example multimodal transportation service according to example implementations of the present disclosure;

FIG. 6B depicts an example flow diagram for providing an example multimodal transportation service according to example implementations of the present disclosure;

FIG. 6C depicts an example flow diagram for providing an example multimodal transportation service according to example implementations of the present disclosure;

FIG. 6D depicts an example flow diagram for providing an example multimodal transportation service according to example implementations of the present disclosure; and

FIG. 7 depicts a block diagram of an example computing system according to example implementations of the present disclosure.

### DETAILED DESCRIPTION

Generally, the present disclosure is directed to addressing conflicting requests for vehicle resources within a distributed transportation computing network. For example, an aerial service provider may coordinate and manage aircraft for transporting users on-demand. These aircraft may be utilized to provide multimodal transportation that includes transporting a user to a destination using at least two different modes of transportation. This can include, for example, transporting a user via a car for a first leg of a journey, via a vertical take-off and lift (VTOL) aircraft for a second leg of a journey, and via another car for a third leg of a journey. To offer this type of multimodal service, ground service providers (e.g., car ridesharing/ride hailing entities) may submit requests to reserve aircraft seats for users in an on-demand fashion. These requests may be submitted through the respective client systems of the ground service providers to a cloud-based computing platform of the aerial service provider.

When multiple ground service providers submit requests at the same time, the requests may conflict with one another. This may occur, for example, in the event that two different service providers are requesting the last seat for a particular flight. The technology of the present disclosure provides a computationally efficient approach for addressing and deconflicting these requests within the complex distributed computing ecosystem used for providing the multimodal transportation services.

To do so, the computing platform of the aerial service provider can be programmed to compute relative priorities between multiple incoming requests. For example, the computing platform may include a request arbitration model that is configured to evaluate incoming requests and prioritize them for seat allocation.

Based on this evaluation, the computing platform can respond to the requests according to their prioritization. Requests associated with higher performance outcomes can be prioritized over another request. A request can be associated with a higher performance outcome in the event it has a lower likelihood of delaying the transportation services or otherwise impacting currently scheduled flights/routes. Additionally, or alternatively, a request can be associated with a higher performance outcome in the event that it may lead to more efficient usage of aircraft, higher transactional value, increased fleet utilization, repeat service engagements, transportation network stability, traffic distribution and load balancing, etc. Higher priority requests can receive a positive response and be fulfilled as requested. Lower priority requests can receive negative responses such that they are rejected or receive next-best candidate alternatives that are available.

By way example, the computing platform may receive a first request for an aircraft seat from a first client system and a second request for an aircraft seat from a second client system. The first client system may be associated with a first ridesharing service and the second client system may be associated with a second ridesharing service. Both the first request and the second request may be requesting the last remaining seat on a particular flight.

The computing platform can allocate the last remaining seat to the client system that submits a request with the higher priority. The priority can be computed based on an evaluation of information associated with the request and the submitting client system. For example, the evaluation can analyze data submitted with the request, such as data descriptive of the user account for which the aircraft seat is requested. The user account information may indicate that the user is a frequent customer, has a high user rating, rarely causes delays, etc. Moreover, the request may indicate travel/time constraints that better align with preexisting flights and assigned users. Additionally, or alternatively, a client system may be associated with a ridesharing service that has a high reliability rating (e.g., for accurate ETAs, etc.). Such information can be ingested by the platform's request arbitration model, which can compute the respective priority for each request.

In this example, the first request may be for a user that is a repeat customer, which has a higher user rating, and the timing constraints align with the currently scheduled flight such that it will not cause delays or any adjustment to the flight schedule. The second request may be associated with timing constraints that would require the flight to take-off later than currently scheduled, causing downstream impacts on the schedules of other aircraft. Moreover, the first ridesharing service that submitted the first request may have a higher reliability rating than the second ridesharing service that submitted the second request. The requestion arbitration model can assign a higher priority to the first request because it has a potentially higher performance outcome given this information. Accordingly, the computing platform can allocate the last remaining seat to the first client system and offer the second client system a seat on an alternative flight or reject the second request.

The technology of the present disclosure can provide a number of improvements to transportation computing technology. For instance, the technology of the present disclosure leverages a specific computing ecosystem that can include a number of computing resources, such as server computing systems, vehicle computing devices, user computing devices, etc. The technology of the present disclosure can coordinate assignment of particular resources to provide a transportation service for a particular client system for servicing a particular request. Advantageously, this assignment can be performed on-demand in substantially real time (e.g., low latency) for coordinating with client systems to provide an on-demand multimodal transportation service.

A request arbitration model according to aspects of the present disclosure can improve the efficiency of such resource assignments. For instance, more efficient resource allocation can provide for increased energy efficiency of vehicles providing the transportation services (e.g., by increasing utilization rates of each transport, such as by avoiding empty flight legs, etc.). For instance, by determining priority statuses based on performance outcomes related to realization of allocated resources, a computing system can increase the overall realization of resource requests, thereby decreasing waste of resources that are held out for requests that are never realized. Further, by prioritizing client requests based on expected high performance, the computing system can facilitate improved stability and continuity of service for users of a multimodal transportation service. Further, example implementations can provide for improved communication protocols between network-connected systems that increase certainty regarding allocation of vehicle slots. This can lead to decreased processing time (e.g., waiting for responses), improved user interfaces (e.g., that operate with less latency), etc. This can improve the joint operation of multiple networked transportation platform computing systems.

The technology of the present disclosure also provides technical improvements through its utilization of real-time data. More specifically, as will be further described herein, computing systems can collect real-time user data and real-time performance data. The real-time user data can be associated with potential users of the transportation network. The real-time performance data can be associated with the resources (e.g., vehicles, facilities, chargers) of the transportation network. Utilization of the real-data can allow the request arbitration model to prioritize competing requests in a manner that most efficiently allocates vehicle slots in an on-demand manner. This is particularly advantageous over traditional scheduling systems, such as systems designed for booking future seat assignments on commercial flights. For example, the conditions of an on-demand transportation network, and its complex distributed ecosystem, may remain fluid throughout an operational time period (e.g., the current day). The on-demand nature of the system allows for more dynamic solutions to fulfill requests than are otherwise available in traditional commercial scheduling systems. To fully realize these dynamic solutions, the technology of the present disclosure can intelligently leverage real-time data that is unique to the on-demand transportation networks described herein, to efficiently and effectively allocate platform resources.

### Example Multimodal Transportation Service

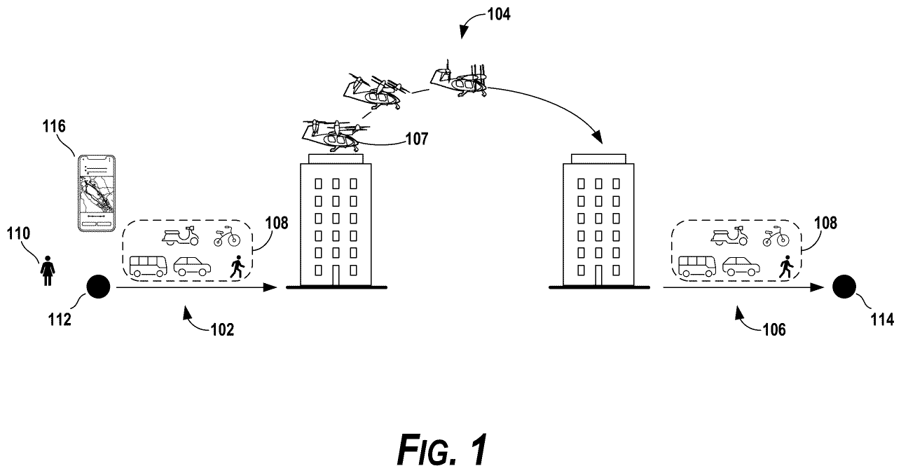

FIG. 1 depicts an example process flow of a multimodal transportation service according to example implementations of the present disclosure. A multimodal transportation service can include multiple transportation legs 102, 104, 106 associated with at least two different transportation modalities. For example, the multimodal transportation service can include a first transportation leg 102, one or more second transportation legs 104, and a third transportation leg 106.

A combination of ground vehicles, aircraft, or other types of vehicles can perform the various legs of the multimodal transportation service. Each transportation leg of the multimodal transportation service can be associated with a respective transportation modality. For instance, the first transportation leg 102 can be associated with a first transportation modality using one or more of ground vehicles 108 such as an automobile. A second transportation leg 104 can be associated with a second transportation modality using an air-based modality such as an aircraft 107. The third transportation leg 106 can be associated with a third transportation modality, which can be the same or different from the first or second modalities. For example, the third transportation leg 106 can use a ground modality such as another automobile, bicycle, walking route, etc.

The multimodal transportation service can be provided in an on-demand manner. The service can include a ridesharing, ride-hailing, or delivery service. The multimodal transportation service can be coordinated for a user 110 by one or more service providers.

A service provider can be an entity that offers, coordinates, manages, etc. a transportation service. This can include a transportation network company, vehicle fleet manager, etc. For example, a user 110 may desire to travel on a journey from an origin location 112 to a destination location 114. The user 110 can interact with a user device 116, via a user interface of a software application, to book transportation for the journey. The user 110 can interact with user device 116 over one or more user sessions.

Based on the user sessions, at least one service entity can compile one or more options for the user 110 to traverse the journey. The user device 116 of the user 110 may present these options to the user 110 via a user interface of the software application. At least one option for the journey can include the multimodal transportation service. Responsive to selection of the multimodal transportation service option by the user 110, the service can be initiated for transportation for user 110.

To track and coordinate the multimodal transportation service, a user itinerary can be computed for the user 110. A user itinerary (also referred to as a “multimodal itinerary”) can be data structure including various information associated with a user's trip from an origin location to a destination location. The user's itinerary may include identifiers for locations of interest (e.g., names/coordinates for origins, destinations, vertiports, etc.), times/durations the user is at each location, transportation modalities, specific vehicle assignments, seat assignments, real-time location data, luggage information, or other information. The user itinerary can be updated in real-time as the user 110 progresses along the journey, in response to any changes to the journey, etc. The user itinerary can be available to the user 110 via the user device 116.

Building user itineraries on-demand across modalities can involve centralized or distributed scheduling of resources associated with each modality. For instance, example implementations can involve systems and devices that interface with user 110, systems and devices associated with a first modality of transportation, and systems and devices associated with a second modality of transportation.

### Computing Ecosystem for Multimodal Transportation Service

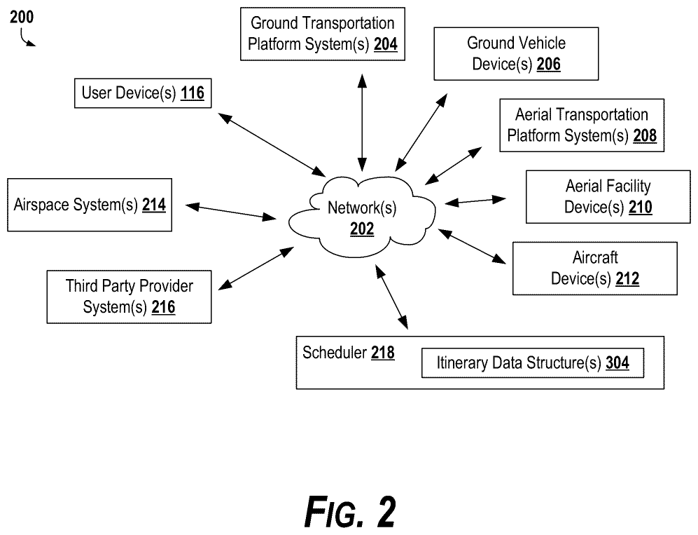

FIG. 2 is a block diagram illustrating an example networked ecosystem 200 for cross-platform coordination for multimodal transportation services. Multiple network-connected systems can cooperatively interact within ecosystem 200 to provide multimodal transportation services. As shown, ecosystem 200 may include a distributed computing system with a plurality of different participating systems/devices communicatively connected over one or more networks 202. Networks 202 can include one or more types of networks including telecommunications networks, internet, private networks, or other networks, as further described herein.

Ecosystem 200 may include one or more user devices 116. User devices 116 can include computing devices owned or otherwise accessible to a user of a transportation service. For example, a user device 116 can include a hand-held computing device (e.g., a phone, a tablet, etc.), a wearable computing device (e.g., smart watch, smart glasses, etc.), personal desktop devices, or other devices. User devices 116 can execute one or more instructions to run an instance of a software application for a respective transportation platform and present user interfaces associated therewith. User devices 116 can include personal devices (e.g., a mobile device) or shared devices on which a user has initiated a personal session (e.g., by logging into a public kiosk or display device in a vehicle, etc.).

Ecosystem 200 can include one or more ground transportation platform (GTP) systems 204. A GTP system 204 can be associated with a service entity that provides a ground transportation service. GTP systems 204 can include a computing platform (e.g., a cloud services platform, server system, etc.) communicatively connected over networks 202 to one or more of the systems or devices of networked ecosystem 200.

GTP systems 204 can include or implement one or more client-facing software applications accessible to the devices of ecosystem 200. Users can interact with the GTP systems 204 (e.g., using user devices 116, ground vehicle devices 206, aircraft devices 212) to receive various types of transportation services (e.g., delivery, ridesharing, or ride-hailing, etc.) including the multimodal transportation services described herein. For example, a GTP system 204 can match one of its associated ground vehicles or operators with users for a ground transportation service.

GTP systems 204 can be associated with ground infrastructure for facilitating the performance of a ground transportation service. The ground infrastructure can include one or more parking areas, vehicle transfer hubs, charging/fueling locations, storage facilities, etc.

GTP systems 204 can be associated with a fleet of ground vehicles and the vehicle operators can include a network of ground vehicle operators. As described herein, ground vehicles can include automobiles, bikes, scooters, autonomous vehicles, etc. The network of ground vehicle operators can include drivers or remote operators that facilitate, oversee, or control the movement of ground vehicles available to perform ground transportation services.

Ecosystem 200 may include ground vehicle devices 206. Ground vehicle devices 206 can include computing devices or systems associated with a ground vehicle or operator. For example, ground vehicle devices 206 can include one or more vehicle computing systems such as, for example, an onboard computer for operating the vehicle, an autonomy system, an infotainment system, etc. Additionally, or alternatively, ground vehicle devices 206 can include an operator's user device. For example, a ground vehicle device can be a driver's mobile phone. In some implementations, ground vehicle devices 206 can include a user device that remains onboard a ground vehicle such as, for example, a tablet that is available to an operator or passenger.

Ecosystem 200 may include one or more aerial transportation platform (ATP) systems 200. An ATP system 208 can be associated with one or more service entities that provide at least an aerial transportation service to users. ATP system 208 can include a computing platform (e.g., a cloud services platform, server system, etc.) communicatively connected over networks 202 to one or more of the systems or devices of networked ecosystem 200.

ATP systems 208 can include or implement one or more client-facing software applications accessible to the devices of ecosystem 200. Users can interact with ATP system 208 (e.g., using user devices 116, ground vehicle devices 206, aircraft devices 212) to receive various types of information related to a transportation service. For example, a user (e.g., a rider) can interact with ATP system 208 via an instance of a software application (e.g., a rider app) running on user device 116 to request and book a multimodal transportation service. A facility operator can interact with ATP system 208 via an instance of a software application (e.g., an operations app) running on an aerial facility device 210 (e.g., a facility operator user device) to view/adjust flight information, seat assignments, etc.

ATP systems 208 can be associated with one or more aircraft, aircraft operators, aerial facilities (or portions thereof), facility operators, etc. for facilitating the performance of at least an aerial transportation service. For example, the aircraft can include a fleet of aircraft, and the vehicle operators can include a network of aircraft operators. The network of aircraft operators can include pilots or remote operators that facilitate, oversee, or control the movement of aircraft available to perform aerial transportation services.

Aerial facilities used for providing a transportation service can include one or more aerial facility devices 210 or one or more facility operators. Aerial facility devices 210 can be positioned at various locations within or around the aerial facility to collect and receive information associated with an aerial transportation service. Aerial facility devices 210 can include one or more charging devices associated with charging infrastructure of the aerial facility, one or more vehicle positioning devices (e.g., motorized tugs, etc.), one or more sensors or surveillance devices (e.g., noise sensors, cameras, etc.), etc. Facility operators can be associated with an aerial facility to assist users with security checks, check-ins, boarding/de-boarding, performing aircraft checks, etc. Aerial facility devices 210 can include facility operator user devices, such as user devices used by the facility operators. Facility operator user devices can be used to communicate with a transportation platform or perform various functions at an aerial facility. For example, facility operator user devices can run one or more software applications to complete security checks, check in/out luggage, coordinate re-charging/re-fueling, present safety briefings, or the like.

Ecosystem 200 can include one or more aircraft devices 212. Aircraft devices 212 can include one or more aircraft computing systems or aircraft operator user devices. For instance, aircraft devices 212 can include a computing system onboard an aircraft such as a pilot interface, an avionics system, an infotainment system, a navigation system, an autonomy system, or any other sensors or devices located on an aircraft and capable of sending or receiving information. Aircraft devices 212 can include an aircraft operator's user device (e.g., a pilot's mobile phone). Aircraft devices 212 can include a user device that remains onboard the aircraft such as, for example, a tablet or display that is available to a passenger or operator.

Ecosystem 200 can include one or more airspace systems 214. Airspace systems 214 can include one or more airspace data exchanges or otherwise be associated with regulatory bodies configured to collect real-time, historical, or regulatory airspace data. The airspace systems 214 can include, for example: (i) aggregating systems that pool airspace data associated with an airspace; (ii) third-party monitoring systems configured to monitor aspects of an airspace (e.g., noise, etc.); or (iii) regulatory systems that can confirm, validate, or approve an aerial transportation service before take-off based on one or more policies or standards set by a regulatory body (e.g., Federal Aviation Administration, European Aviation Safety Agency, etc.).

Ecosystem 200 can include one or more third-party provider systems 216. Third-party provider systems 216 can be associated with one or more third parties that provide resources to ATP systems 208 or GTP systems 204. For example, third-party provider systems 216 can be associated with a third-party aircraft provider, including one or more “third-party” aircraft. Third party aircraft can include aircraft provided, leased, loaned, or otherwise made available by an entity for use by ATP systems 208 for transportation services.

Additionally, or alternatively, third-party provider systems 216 can be associated with a provider of one or more third-party aircraft operators. Third-party aircraft operators can include, for example, a plurality of aircraft pilots that may be available to ATP systems 208 for operation of an aircraft for the transportation services.

In some implementations, third-party provider systems 216 can be associated with a third-party facility provider that can provide facilities (or facility resources) for use in performing transportation services. For example, the third-party facility provider can own, operate, etc. one or more aerial facilities (or portions thereof) that can be rented, leased, or otherwise utilized by a transportation platform system for providing an aerial transportation service. ATP systems 208 or GTP systems 204 can communicate directly or indirectly (e.g., through third-party provider systems 214) with the third-party aircrafts, operators, or infrastructure.

Ecosystem 200 may include a scheduler system 218 that builds on-demand multimodal itineraries. Scheduler 202 can communicate with GTP systems 204 to allocate a ground vehicle (or other ground modality) for transporting a user. Scheduler 202 can communicate with ATP systems 208 to allocate an aerial facility or to allocate space on an aircraft for servicing a leg of a multimodal transportation service.

In some implementations, scheduler 218 can be implemented external to either one or both of GTP systems 204 and ATP systems 208, such as on its own server systems. Scheduler 218 can be a back-end coordination layer that communicates with GTP systems 204 and ATP systems 208.

In some implementations, scheduler 218 can be implemented internally by either one or both of GTP systems 204 and ATP systems 208. For instance, a first system associated with a first type of transportation modality (e.g., ground transport) can be a primary orchestrator that compiles an itinerary using scheduler 218 to request, from a second system associated with a second type of transportation modality (e.g., aerial transport), availability data for assets associated with the second modality. User devices 116 can thus communicate with the first system to access a complete multimodal itinerary.

In some implementations, GTP systems 204 can implement scheduler 218. User devices 116 can communicate with GTP systems 204 to request a transportation service for a journey. For instance, user devices 116 can execute an application associated with the GTP systems 204 (e.g., an application associated with a service entity that controls GTP systems 204). GTP systems 204 can request, from ATP systems 208, availability of aircraft for compiling, with scheduler 218, a multimodal itinerary for providing the transportation service. User devices 116 can receive the proposed multimodal itinerary from GTP systems 204. For instance, user devices 116 can view the proposed multimodal itinerary in the application associated with the GTP systems 204.

In some implementations, ATP systems 208 can implement scheduler 218. User devices 116 can communicate with ATP systems 208 to request a transportation service for a journey. For instance, user devices 116 can execute an application associated with the ATP systems 208 (e.g., an application associated with a service entity that controls ATP systems 208). ATP systems 208 can request, from GTP systems 204, availability of ground vehicles (or walking instructions) for compiling, with scheduler 218, a user itinerary for providing the transportation service. User devices 116 can receive the proposed multimodal itinerary from ATP systems 208. For instance, user devices 116 can view the proposed multimodal itinerary in the application associated with the ATP systems 208.

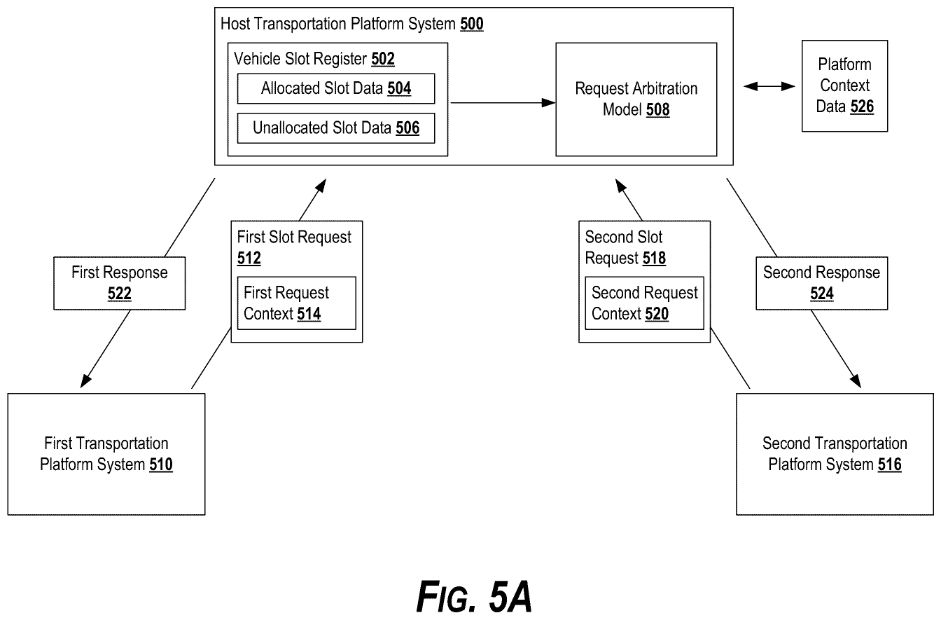

The systems and devices of ecosystem 200 may be registered for potential use when providing and coordinating a multimodal transportation services. FIG. 4B illustrates an example device register 300. Device register 300 can include a table or other data structure indicating devices/systems participating in the on-demand transportation platform ecosystem, such as ecosystem 200. Device register 300 can include fields such as Device ID, Entity, Location, Status, Availability, etc.

In some implementations, scheduler 218 can maintain device register 420 in a local or remote database. Systems and devices can register for participation in ecosystem 200 by providing information to scheduler 218 such as system/device identifiers, associated entities, IP addresses, downloading an application, signing-up or creating an account with scheduler 218, or other information for identifying and communicating with the system/device. Scheduler 218 can update device register 300 to provide a real-time reference for the characteristics and status of participating systems/devices. This can include, for example, determining whether a device is online or offline (e.g., powered on and connected, or not) or whether the device is available (e.g., not currently being utilized for another task) or unavailable (e.g., being utilized for another task).

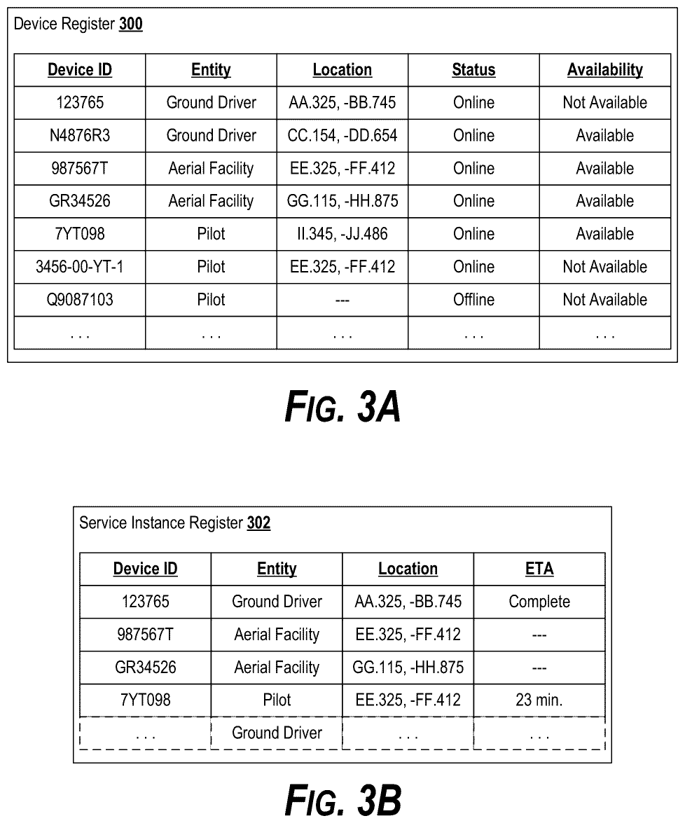

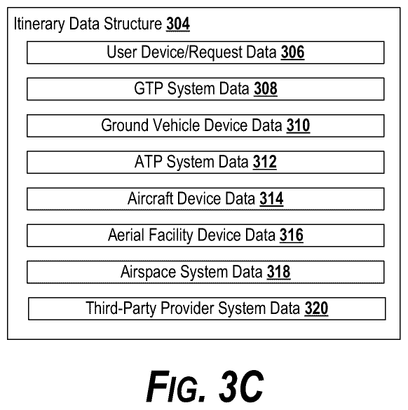

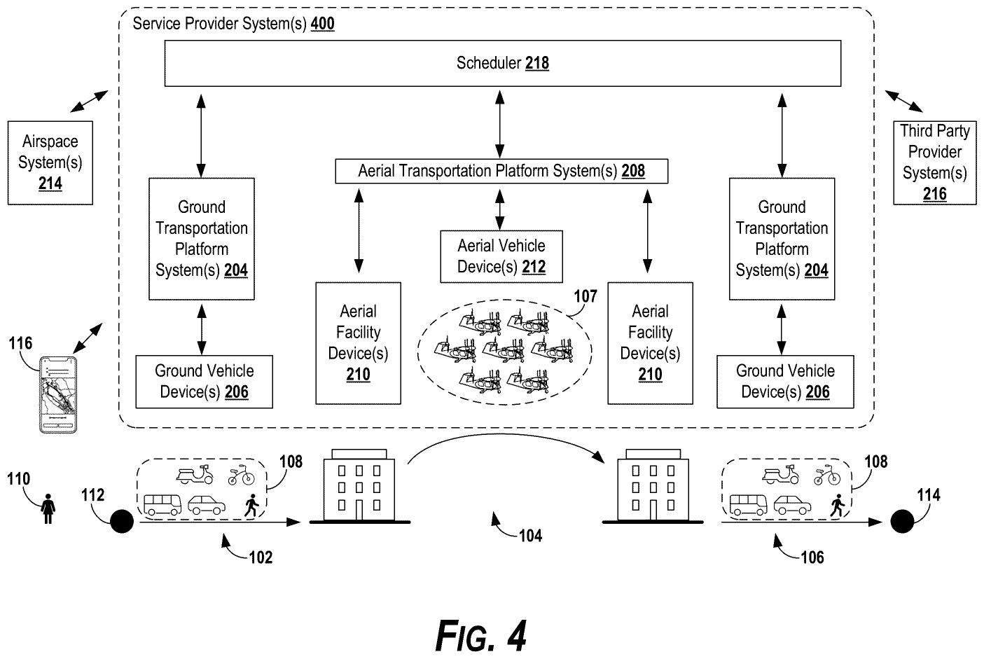

When building a user itinerary, scheduler 218 can generate a service instance register, such as an example service instance register 302 shown in FIG. 3B. A service instance register can include a data structure with one or more data objects that indicate the devices to be utilized for facilitating and progressing a user along their journey.

Scheduler 218 can build a service instance register 302 for servicing a particular service request. Service instance register 302 can be associated with a unique or distinct service instance identifier for a particular user itinerary for providing at least one leg of a transportation service. Service instance register 302 can assemble a selection of participating devices from device register 300. Service instance register 302 can include a minimum set of participating devices to complete at least a leg of a journey. Service instance register 302 may include all participating devices to complete the entire leg of a journey.

Scheduler 218 can update and reconfigure service instance register 302 as needed to accommodate for scheduling changes, delays, device substitution, etc. or as the journey/itinerary progresses for a particular user. For example, as the user progresses along a second leg 104 of a particular journey, the scheduler 218 may identify and select a ground vehicle for servicing the last leg of the user's journey. In response, the scheduler 218 may identify, in device register 300, the ground vehicle device associated with the selected ground vehicle and lists the device in the service instance register 302. In this manner, the scheduler 218 may associate systems/devices with each particular service instance for the users of the multi-model transportation service.

Facilitating an on-demand multimodal transportation service can involve complex coordination between multiple different systems and devices for allocating respective resources of each system to perform the various tasks associated with the on-demand multimodal transportation service. To help accommodate a particular service request, scheduler 218 can generate itinerary data structures 304, as shown in FIG. 3C. Itinerary data structures 304 can include, for a particular user itinerary, a plurality of data objects that describe allocations of the respective resources from the participants in ecosystem 200.

FIG. 3C is a block diagram of example features of itinerary data structure 304.

Itinerary data structure 304 can store information associated with a particular user itinerary. This information may be stored in a platform system, remote from the user. Some of all, of the information may be collected in real-time for use in implementing the technology of the present disclosure. Some, or all, of the information may be provided or made available to a user. For example, at least a portion of the data described herein with respect to FIG. 3C may be presented to the user when selecting a transportation option via a software application and/or after the user selects the transportation option.

Itinerary data structures 304 can include data computed or communicated by the systems/devices of ecosystem 200. For instance, itinerary data structures 304 can include one or more data objects that include user device/request data 306, GTP system data 308, ground vehicle device data 310, ATP system data 312, aircraft device data 314, aerial facility device data 316, airspace system data 318, or third-party provider system data 320.

User device/request data 306 can include various types of information. For example, user device/request data 306 can include data descriptive of a particular service request for which the user itinerary is generated. User device/request data 306 can include data descriptive of a user account for which the user itinerary is generated. User device/request data 306 can include a user account identifier associated with a session during which a particular service request was submitted.

GTP system data 308 and ground vehicle device data 310 can include data descriptive of assignments of ground service system assets for servicing a particular service request. This can include identifiers of ground vehicles or operators, associated locations (e.g., origin locations, destination locations, current locations), statuses (e.g., online/offline), availability (e.g., available because not on-trip, unavailable because on-trip), and/or other information.

ATP system data 312, aircraft device data 314, and aerial facility device data 316 can include data descriptive of assignments of aerial service system assets for servicing a particular service request. This can include identifiers of aerial facilities, aircraft, or operators, associated locations, statuses, availability, and/or other information.

Airspace system data 318 can include various information associated with the airspace in which aircraft operate. This can include data descriptive of weather, air-traffic, or regulatory approval for flight operations in an airspace. In some implementations, airspace system data 318 can include approved routes, flight paths, etc.

Third-party provider system data 320 can include data descriptive of assignments of third-party system assets for serving a particular service request. This can include the identifiers, locations, statuses, availability, etc. of third-party aircraft or operators.

The systems/devices of ecosystem 200, as well as the data associated therewith, can be utilized to efficiently coordinate a multimodal transportation service.

### Example Data Flow for Computing Ecosystem for Multimodal Transportation Service

To help improve the performance of ecosystem 200 for efficiently allocating resources across multiple different systems and modalities, example implementations of the present disclosure provide a vehicle request coordination system that contains scheduler 218. As will be described in the example computer communication flow of FIG. 4, scheduler 218 can coordinates requests from multiple client systems for space on one or more vehicles (e.g., aircraft operated by an ATP, etc.) for building an on-demand multimodal transportation itinerary.

FIG. 4 is a block diagram illustrating systems and devices that can respectively correspond to the various modalities of an example multimodal transportation service. FIG. 4 illustrates how the various computing devices of computing ecosystem 200 may be implemented and interact with one another within the context of the end-to-end multimodal journey described with reference to FIG. 1, as well as example data flows associated therewith.

User 110 can interact with software operating on user device 116 to communicate with one or more service provider systems 400 to request a transportation service. The service provider systems can include, for example, GTP systems 204 or ATP systems 208. The service provider systems 400 can also include devices associated with the vehicles and facilities used in a multimodal transportation service. Service provider systems 400 can include scheduler 218 that builds on-demand multimodal itineraries. The service providers can communicate with airspace systems 214 or third-party provide systems 216 to help coordinate the transportation services.

### Example ATP Client-Facing System Implementation

Still with reference to FIG. 4, in some implementations, an ATP system 208 can be a client-facing system that receives a user request and builds a multi-model itinerary for a user 110. In such an implementation, scheduler 218 may be a component of (or accessible to) the ATP system 208 to help compute the itinerary.

For instance, a user device 116 can communicate with an ATP system 208 to request a transportation service for a journey. The user device 116 can execute an application associated with the ATP system 208. This can be an application associated with a service entity that controls the ATP system 208. The ATP system 208 can access availability data for its aircraft to identify, or create, a flight for transporting the user 100 along an aerial leg of the journey (e.g., second leg 104). Based on the flight, the ATP system 208 (using scheduler 202) can request, from one or more GTP systems 204, availability of ground vehicles for transporting the user 110 along a leg preceding the aerial leg (e.g., first leg 102) and along a leg succeeding the aerial leg (e.g., third leg 106). Additionally, or alternatively, user walking instructions may be provided for these legs. The ATP system 208 can, with scheduler 202, compile a multimodal itinerary for providing the transportation service.

The ATP system 208 can communicate the compiled itinerary to the user device 116. The user device 116 can receive the proposed multimodal itinerary from ATP system 208 and present it for selection by the user 110. For instance, the user 110 can view the proposed multimodal itinerary in a user interface of the application associated with the ATP system 208.

In the event the user selects the multimodal itinerary, the ATP system 208 can communicate with certain devices to coordinate the user's journey. For example, the ATP system 208, with scheduler 218, can communicate with GTP systems 204. The GTP systems 204 can communicate with one or more ground vehicle devices 206 to assign a vehicle for the user 110 for the first transportation leg 102 and a vehicle for the third transportation leg 106. The assignment of the vehicle for the third transportation leg 106 may occur before, or while, the user 110 is travelling along the journey (e.g., during the second leg 104). The ATP system 208 can communicate with aerial facility devices 210 to provide them with information regarding the user's journey. This can help facilitate the user's transition between the different legs at the respective aerial facilities. The ATP system 208 can communicate with aircraft devices 212 to provide seat assignments or other flight information for the aircraft 107 that is assigned to transport the user 110.

In some implementations, the service entity associated with the ATP system 208 may have a fleet of ground vehicles for providing ground transportation to the user 110. As such, the GTP systems 204 may be internal client systems for communicating with these ground vehicle fleets.

### Example GTP Client-Facing System Implementations

Still with reference to FIG. 4, in some implementations, a GTP system 208 can be a client-facing system that receives a user request and builds a multimodal itinerary for a user 110. In such an implementation, scheduler 218 may be a component of (or accessible to) the GTP system 206 to help compute the itinerary.

For instance, a user device 116 can communicate with a GTP system 208 to request a transportation service for a journey. The user device 116 can execute an application associated with the GTP system 204. This can be an application associated with a service entity that controls the GTP system 204 such as, for example, a ground vehicle ridesharing/hailing app.

The GTP system 204, with scheduler 218, can request a vehicle slot on an aircraft of one or more ATP systems 208. As will be further described herein, a vehicle slot can include a seat for the user 110 and/or cargo space for the user's luggage or delivery item. The ATP systems 208 can access availability data for its aircraft to identify, or create, one or more candidate flights for transporting the user 110 along an aerial leg of the journey (e.g., second leg 104).

In some implementations, the ATP system 208 can provide the information associated with the candidate flights to the GTP system 204. This can include take-off/landing times, boarding times, departing/arrival facilities, aircraft identifiers, or other information. Based on the candidate flights, the GTP system 204 may identify its available ground vehicles for transporting the user 110 along the first transportation leg 102 and third transportation leg 106. Additionally, or alternatively, user walking instructions may be provided for these legs. The GTP system 204 can, with scheduler 202, compile a multimodal itinerary for providing the transportation service.

The GTP system 208 can communicate the compiled itinerary to the user device 116. The user device 116 can receive the proposed multimodal itinerary from the GTP system 204 and present it for selection by the user 110. For instance, the user 110 can view the proposed multimodal itinerary in a user interface of the application associated with the GTP system 204.

In the event the user selects the multimodal itinerary, the GTP system 204 can communicate with certain devices to coordinate the user's journey. For example, the GTP system 204, with scheduler 218, can communicate with ATP systems 208. The ATP systems 208 can communicate with aerial facility devices 210 to provide them with information regarding the user's journey, as described herein. The ATP system 208 can communicate with aircraft devices 212 to provide seat assignments or other flight information for the aircraft 107 that is assigned to transport the user 110.

The GTP system 204 can communicate with one or more ground vehicle devices 206 to assign a vehicle for the user 110 for the first transportation leg 102 and a vehicle for the third transportation leg 106. The assignment of the vehicle for the third transportation leg 106 may occur before, or while, the user 110 is travelling along the journey (e.g., during the second leg 104).

In some implementations, the GTP system 204 may be the user-facing system that receives the user's transportation request, but ATP systems 208 may include scheduler 218 and be configured to build an itinerary for the GTP system 204. For instance, the GTP system 204 may request, from one or more ATP systems 208, a flight or a multimodal itinerary for the user 110. The ATP systems 208 may compute a multimodal itinerary based on availability data for its aircraft and data indicating ground vehicle availability, which may be accessed via the GTP system 204. The ATP systems 208 may communicate the itinerary to GTP system 204 for provision to the user 110.

In the event that multiple GTP systems 204 submit requests for slots on aircraft, the requests may conflict such that both requests cannot be allocated seats/space on an aircraft at the same, requested time.

### Example Systems for Addressing Conflicting Resource Requests

The technology of the present disclosure provides techniques for addressing conflicting requests within a distributed computing ecosystems, such as those described herein for coordinating multimodal transportation services. As described below, this can include the utilization of certain models that help efficiently allocate platform resources from a host transportation platform. Use of the term “host transportation platform” herein is to be understood to provide flexibility for multiple embodiments. As further described herein, a host transportation platform may include an ATP platform system 208 or a GTP platform system 204.

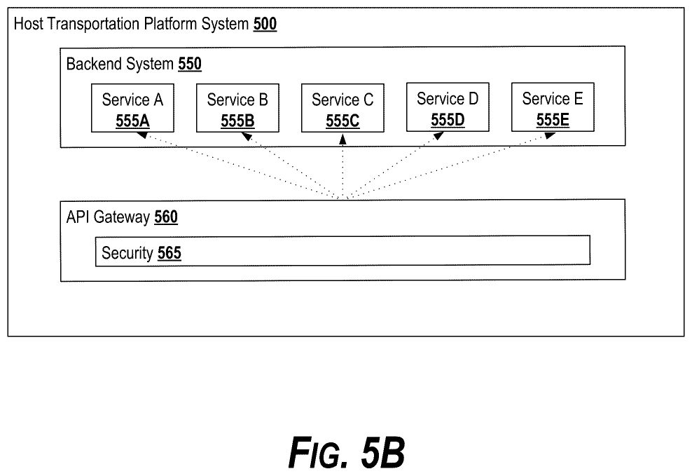

FIG. 5A depicts an example implementation of a computing ecosystem configured to coordinate a schedule for vehicle slots associated with a fleet of vehicles. A vehicle slot can be substantially any type of space or portion of a resource on a vehicle in the fleet. For instance, a vehicle slot can be a seat for a rider in the vehicle. A vehicle slot can be a cabin with multiple seats. A vehicle slot can be a portion of a cargo area providing storage space for transporting cargo. A vehicle slot can be a portion of another resource onboard the vehicle, such as stored electricity, liquid (e.g., fuel, water, oil, chemicals, etc.), or other items, products, etc.

A vehicle slot can be associated with a particular time period. For instance, a vehicle slot can be described as a particular resource at a prescribed time. For instance, in some examples a single seat on an aircraft can be associated with multiple slots at different times, such as for example a slot corresponding to each of multiple flights. In some examples the single seat can be associated with a single slot for which availability is mapped over time, such that availability can be described differently with respect to each flight.

As shown, FIG. 5A includes host transportation platform (“HTP”) system 500, first transportation platform system 510, and second transportation platform system 516. The systems can communicate by accessing one or more application programming interfaces (APIs) over one or more networks. For example, first transportation platform system 510 or second transportation system 516 can access an API of HTP system 500 for structuring communications with the HTP system 500. Moreover, first transportation platform system 510 or second transportation system 516 can establish a session for communicating with the HTP system 500 through structured requests and other transmissions via a communication channel between the systems.

HTP system 500 can be, include, or be included in or otherwise implemented by scheduler 218, GTP systems 204, or ATP systems 208. For instance, an air transportation service provider entity (e.g., associated with an ATP system 208) can operate HTP system 500 to coordinate utilization of its vehicular resources (e.g., aircraft). The HTP system 500 can be associated with an aerial transport provider that maintains a vehicle slot register 502 and can allocate vehicle slots for other service providers.

HTP system 500 can include a cloud-based computing platform. For example, FIG. 5B depicts an example computing architecture of HTP system 500. HTP system 500 can include a backend system 550 that hosts a plurality of services 555A-E (e.g., microservices). The HTP system 500 may include a graph that aggregates across the services 555A-E. Each respectively programmed to perform a function for the HTP system 500.

For instance, as described herein, HTP system 500 may include or represent an ATP system 208 that coordinates aerial transportation services. The services 555A-E may perform functions for generating flights and assignment vehicle slots for those flights. By way of example, a first service 555A may be configured to identify available aircraft, a second service 555B may be configured to identify available pilots, a third service 555C may be configured to determine available flight times, skylanes, and routes, a fourth service 555D may be configured to compute charging and maintenance needs, a fifth service 555E may be configured to allocate vehicle slots for the aircraft, and so on. The services 555A-E may host or other implement the request arbitration model 508.

The services 555A-E may collect real-time data to perform their respective functions. This may include real-time data associated with a user or real-time performance data. As further described herein, the real-time data may be utilized to address conflicting requests for platform resources.

Another computing system may transmit a communication to HTP system 500 to request data. For instance, the HTP system 500 (or an entity associated therewith) may publish a software development kit (SDK) that allows another computing system to structure messages according to the APIs of the HTP system 500. The structured messages may include requests for data such as, for example, a request for an allocated vehicle slot, flight information, etc.

HTP system 500 may receive a structured message at API gateway 560. API gateway 560 may be configured to validate access to the requested data and orchestrate a call to each service 555A-E that would be needed to provide the requested data. API gateway 560 may validate a message through security layer 565 that includes functions for message validation. By way of example, API gateway 560 may validate a message by determining that required request parameters (e.g., in the URI, query string, headers) of an incoming request are included and non-blank and/or the applicable request payload adheres to a configured scheme request model of the security layer. When the validation fails, API gateway 560 may fail the request and return an error response to the caller computing system.

In the event a message is validated, API gateway 560 can call the service 555A-E to gather and compile data to respond to the request. For example, to respond to a vehicle slot allocation request, API gateway can call: the first service 555A to determine an available aircraft; the second service 555B to determine that an operator is assigned or available to operate the aircraft; the third service 555C to determine the times and routes of the aircraft; and the fifth service 555A to determine whether a vehicle slot is available. In some implementations, API gateway 560 may call service 555D to determine whether the charging/maintenance parameters of the aircraft would be affected by adding a rider to the aircraft. The API gateway 560 can compile this data for the HTP system 500 to transmit a response (indicative of the vehicle slot allocation) to the caller computing system.

Returning to FIG. 5A, first transport platform system 510 and the second transportation platform system 516 can be associated with service providers that are different than that of the HTP system 500. For example, first transportation platform system 510 can be associated with a first ground transport provider (e.g., an app-based ride hailing company), while second transportation platform system 516 can be associated with a second ground transport provider that is different from the first ground transport provider (e.g., a different app-based ride hailing company). First transportation platform system 510 and second transportation platform system 516 can be GTP systems 204. One or more GTP systems 204 can thus be client systems that submit requests to the HTP system 500 (e.g., an ATP system 208) to obtain aerial transportation services for a multi-leg multimodal journey.

In some implementations, at least one of first transportation platform system 510 or second transportation platform system 516 can be an internal client system. For instance, HTP system 500 can be operated by a service provider associated with an ATP system 208. At least one of first transportation platform system 510 or second transportation platform system 516 can be an internal client system also operated by that entity. For example, HTP system 500 can be implemented by an ATP system 208. ATP system 208 can also include first transportation platform system 510 as a user-facing system for engaging with or otherwise accessing the transportation services provided by the ATP system 208. This may be, for example, to access ground transportation services also offered by the HTP systems 500 in addition to aerial transportation services. As such, first transportation platform system 510 can be an internal client system requesting allocation of vehicle slots. Other transportation service providers can operate external client systems. For instance, these other transportation service providers can operate second transportation platform systems 516 that request allocation of vehicle slots for building multimodal itineraries.

In some implementations, a ground transportation service provider entity (e.g., associated with a GTP system 204) can operate HTP system 500 to coordinate utilization of its vehicular resources. These vehicular resources can include ground vehicles, such as automobiles, autobuses, trains, bicycles, etc. One or more ATP systems 208 (e.g., directly, indirectly via scheduler 202) can thus be client systems that submit requests to the GTP system 204 to obtain ground transportation services along a multi-leg multimodal journey compiled by scheduler 202.

HTP system 500 can contain a vehicle slot register 502. The vehicle slot register 502 can contain allocation data descriptive of a current state of allocation of vehicle slots. For instance, vehicle slot register 502 can contain allocated slot data 504 and unallocated slot data 506. HTP system 500 can manage allocation of the vehicle slots in vehicle slot register 502 using request arbitration model 508.

For instance, as described herein HTP system 500 can be an ATP system associated with a fleet of aircraft. A first transportation platform system 510 can transmit, to HTP system 500, a first slot request 512 (optionally containing first request context 514). The first slot request 512 can request a vehicle slot for providing a transportation service along a leg of a multimodal transportation service. A second transportation platform system 516 can transmit, to HTP system 500, second slot request 518 (optionally containing second request context 520). The second slot request 518 can request a vehicle slot for providing a transportation service along a leg of a multimodal transportation service. HTP system 500 can evaluate the first slot request 512 and the second slot request 518 against the vehicle slot register 502 to determine whether vehicle slots are available to service the requests.

If first slot request 512 and second slot request 518 are submitted with conflicting service criteria, HTP system 500 can submit the requests to request arbitration model 508 to determine which request takes priority over the other. As further described herein, based on outputs of the request arbitration model 508, HTP system 500 can output first response 522 to first transportation platform system 510 and second response 524 to second transportation platform system 516. For instance, the first response 522 can include confirmation of the requested vehicle slot. Second response 524 can include denial of the requested vehicle slot, and optionally, a suggested alternative vehicle slot.

Vehicle slot register 502 can be or include a data structure configured to organize an inventory of vehicle slots. For instance, allocated slot data 504 can indicate slots which have been allocated for performing transportation services. Unallocated slot data 506 can describe slots that are available for assignment for performing transportation services.

Allocated slot data 504 can indicate a recipient of an allocation. The recipient can be an entity to which the slot is allocated.

Allocated slot data 504 can indicate a type of allocation. For instance, a type of allocation can include a realized allocation. A realized allocation can be an allocated vehicle slot that has been actually or effectively confirmed, filled, occupied, etc. Confirmation can include consummation of a transaction such as, for example, a commitment to or payment of a fee, deposit of a digital token, etc.

In some implementations, a type of allocation can include a pending allocation. A pending allocation can be an allocated vehicle slot that has been associated with servicing a particular request, awaiting confirmation, cancellation, or the like. A pending allocation can be assigned an expiration. For instance, a pending allocation can be configured to expire if not confirmed within a prescribed time period. The prescribed time period can include a time period referenced to a time of request, a time period referenced to a time of departure of the requested vehicle slot, etc. A pending allocation can be configured to expire if not confirmed before any other set point is reached. An example set point can include a number of additional requests for the same vehicle slot.

By way of example, second transportation platform system 516 can transmit second slot request 518 to obtain a vehicle slot to populate a user interface of a user-facing application. A user can interact with a user application associated with the second transportation platform to obtain a transportation service. The user application can be configured to present the user with multiple itinerary options for the user to review and select. Thus, an allocation communicated in second response 524 can be a pending allocation until the transaction is confirmed by the user selecting the itinerary leveraging the vehicle slot. At that point, the allocation can remain pending until the itinerary can no longer be canceled, or the allocation can be updated from pending to realized. If the user does not select the itinerary leveraging the vehicle slot, then the allocation can be released.

In some implementations, a type of allocation can be a preallocation. A preallocation can include a quota of vehicle slots to be reserved for servicing requests from a particular client system. One or multiple client systems can be associated with a preallocated quantity of vehicle slots. Vehicle slots that are allocated responsive to a request from such a client system can be counted against that client system's preallocation quantity.

The preallocation quantity can be a quota defined with respect to various bases. In some implementations, a time period can be used as a basis. This can include, for example, allocating one-hundred (100) vehicle slots per day guaranteed. Additionally, or alternatively, a proportion of vehicle slots in a vehicle can be used as a basis. This can include, for example, allocating at least two slots available per vehicle guaranteed.

The preallocation quantity can be adjusted based on lead time. For instance, a quota can guarantee a given number of vehicle slots if sufficient notice is provided. Sufficient notice can include, for example, notice exceeding a specified time interval. The specified time period can be at least one, two, three, etc. days in lead time.

In some implementations, a preallocation quantity can guarantee a different number of vehicle slots if less notice is provided. For example, one-hundred (100) slots may be pre-allocated if more than four days' notice is provided, while seventy-five (75) slots may be pre-allocated if more than three days' notice is given.

Allocated slot data 504 can include data describing a wait list for vehicle slots. For instance, multiple client systems can request a vehicle slot meeting certain criteria, as further described below. Some client systems may be denied the allocation based on the criteria. Such client systems can be placed on a waitlist for that or for similar vehicle slots. As additional allocations become available (e.g., upon expiry of a pending allocation), the waitlisted client systems can receive notice that the allocation has become available. The waitlisted client systems can then determine whether to accept the allocation if still of use.

Allocated slot data 504 and unallocated slot data 506 can include data describing the vehicle slots. For instance, data describing the vehicle slots can include a slot identifier. The slot identifier can include a unique or distinct value assigned to a particular vehicle slot. Data describing the vehicle slots can include descriptors of type, size, capacity, level (e.g., luxury level, accommodation level, etc.), etc. of the vehicle slot. Data describing the vehicle slots can include data describing the vehicle itself, including a type of vehicle, capacity of vehicle, comfort level of vehicle, maintenance status of vehicle, etc.

Data describing the vehicle slots can include vehicle itinerary data, such as data indicating one or more destinations of the vehicle itself, or whether a destination is not yet assigned. Vehicle itinerary data can include departure times and arrival times at one or more locations. Vehicle itinerary data can include data describing, for allocated vehicle slots, a user itinerary associated with the vehicle slot.

First slot request 512 and second slot request 518 can be data structures configured to communicate or otherwise initiate a request for allocation of a vehicle slot to the requesting system. The requests can directly request availability of a vehicle slot independently or can request availability of a vehicle slot as part of a multi-leg, multimodal itinerary generated by the HTP system 500.

First slot request 512 and second slot request 518 can be indicative of criteria, such as, one or more constraints associated with the request. A constraint can be a time constraint, such as a departure time, arrival time, or duration. A constraint can be a location constraint, such as a departure location, arrival location, or intermediate locations (e.g., connecting locations). Location constraints can include a designation of a particular location. Location constraints can include designation of an acceptable region for selecting the constrained location. A constraint can be a capacity constraint. Capacity constraints can include a number of seats, a quantity of cargo space, etc.

First slot request 512 and second slot request 518 can communicate context data descriptive of a context associated with the requests. First request context 514 can include the context data associated with first slot request 512. Second request context 520 can include the context data associated with second slot request 518.

Context data can include data descriptive of the sending client system, such as a client platform identifier (e.g., the client service provider identifier). Context data can include data describing other legs of a multimodal itinerary in which the requested vehicle slots are to be included. The context data can indicate a type of transport used for another leg. This can include, for example, a dedicated car service, shared car service, walk, or other modes of transport. The context data can indicate temporal data associated with the leg, such as data indicating a variance of an estimated time of arrival at the departure location for the requested vehicle slot.

The context data can include user account data associated with a user on whose behalf the transportation service is being performed. As described herein, the user can be a rider for the multi-leg journey. The user account data can include a user account status. This can include a subscription status, a reward status, a high-use status, a blocked or unpermitted status, etc. The user account data can indicate an activity level describing whether the user is an active/frequent traveler and the user's travel patterns, etc. The user account data can indicate an activity history, such as favorited or bookmarked locations. The user account data can indicate user timeliness patterns. The timeliness patterns can indicate the frequency, occurrences, locations, etc. of how often a user causes a delay or is on time. This can include making a ground vehicle or aircraft wait for the user.

HTP system 500 can receive, store, and update platform context data 526. Platform context data 526 can include data describing performance metrics associated with one or more client systems, such as first transportation platform system 510 and second transportation platform system 516. Performance metrics can be associated with a client platform identifier.

Performance metrics can be based on realization rates. In some implementations, a realization rate can include a ratio of pending to realized allocations for a given client system. Performance metrics can include a timeliness component for evaluating the likelihood of delays caused by the service provider (or user) associated with a given client system. The timeliness component can be indicative of a number of instances of delay, aggregate delayed time, or other measurements of delay. Performance metrics can include a reliability component that indicates a completion rate or cancellation rate associated with the transportation platform systems, such as for example measured based on transportation services completed or canceled by the service provider. Performance metrics can include a user feedback component, such as user feedback on an experience with the respective service provider/transportation platform.

Platform context data 526 can include quality measurements associated with a given platform. For instance, HTP system 500 can generate and process log data to compute quality measurements associated with a particular transportation platform submitting the request. For instance, HTP system 500 can record log data describing a performance of multi-leg multimodal itineraries that include the allocations output by the system to various transportation platforms. The log data can describe timeliness of the legs of the itinerary, quality of the service (e.g., as reflected in user feedback scores), cost of the service, and the like. HTP system 500 can process the log data to compute a quality measurement associated with the corresponding transportation platforms. The quality measurements can be expressed as a number (e.g., 1-100), level (e.g., low, medium, high), grade, percentage, etc. Requests from a client system corresponding to a transportation platform with a higher overall quality measurement can be prioritized by the HTP system 500.

Request arbitration model 508 can process first slot request 512 and second slot request 518 to resolve conflicts between the requests. For instance, first slot request 512 and second slot request 518 can each request a vehicle slot from the same departure location at the same time to the same destination. If only one vehicle slot (e.g., seat) is available, this can present a conflict between the requests. Request arbitration model 508 can process first slot request 512 and second slot request 518 to determine which request to satisfy and which request to deny.

Request arbitration model 508 can include a rules-based model. The rules-based model can include one or more rules (e.g., heuristic functions) for processing, prioritizing, and allocating slot requests. This can include rules for weighing certain data or metadata across other data ingested by the model. The rules can also include heuristics for computing a score, as further described herein. Moreover, the rules can include those for prioritizing or selecting a slot request over another and outputting such information.

Request arbitration model 508 can be or include one or more machine-learned models or components. Request arbitration model 508 can include one or more weights or features that have been learned by iteratively evaluating an output of the model against a desired reference output. Request arbitration model 508 can include one or more weights or features that have been learned by automatically seeking a feedback signal received (e.g., a reward or a penalty) based on its arbitration decisions to, for example, reduce a loss associated with a loss function. A feedback signal can include user feedback, client system feedback, client system performance metrics (e.g., client system reliability, quality ratings), host system performance metrics (e.g., vehicle utilization rates, efficiency rates), and the like.

Request arbitration model 508 can be or can otherwise include various machine-learned models such as, for example, transformer models, regression networks, generative adversarial networks, neural networks (e.g., deep neural networks), support vector machines, decision trees, ensemble models, k-nearest neighbors models, Bayesian networks, or other types of models including linear models or non-linear models. Example neural networks include feed-forward neural networks, recurrent neural networks (e.g., long short-term memory recurrent neural networks), convolutional neural networks, or other forms of neural networks.

A training computing system, such as HTP system 500, can train request arbitration model 508 using training data. One example training technique is backwards propagation of errors. In some implementations, the training computing system can perform supervised training techniques using a set of labeled training data. In other implementations, the training computing system can perform unsupervised training techniques using a set of unlabeled training data. The training computing system can perform a number of generalization techniques to improve the generalization capability of the models being trained. Generalization techniques include weight decays, dropouts, or other techniques.

For example, training data can include historical platform data. The historical platform data can include prior request data, prior itineraries, platform context data 526, etc. The historical platform data can include performance metrics associated with prior itineraries and quality measurements associated with participating transportation service providers.

A training objective can be based on training the request arbitration model 508 to improve the performance metrics or quality measurements associated with user itineraries composed based on the prioritization of conflicting requests. For instance, the historical platform data can be fed as inputs to request arbitration model 508, such as by inputting historical slot requests to request arbitration model 508. This can be performed in an online fashion as the slot requests are processed by the system at runtime. Performance metrics associated with any resulting itineraries and quality measurements associated therewith can be obtained as feedback signals. These feedback signals can be used to adjust one or more parameters of request arbitration model 508. For instance, a reinforcement learning technique can be applied to update one or more parameters of request arbitration model 508 based on a reward. The reward can be obtained based on positive performance metrics associated with the itineraries and positive quality measurements associated therewith. Additionally, or alternatively, one or more parameters of request arbitration model 508 can be based on a penalty. The penalty can be received based on negative performance metrics associated with the itineraries and negative quality measurements associated therewith.

Request arbitration model 508 can provide a classification output, such as “approve” and “deny.” The request arbitration model 508 can provide a regression output, such as a value or score. The request arbitration model 508 can output a score for a given request. The score can be absolute or relative, such as relative to one or more other requests. The score can be used to prioritize responses to the various requests.

For example, HTP systems 500 can provide, in response to a higher priority request (e.g., a request associated with a more favorable score), an allocation of a vehicle slot providing the highest quality available match to the request constraints. This highest available match can include the exact vehicle slot requested. Lower priority requests can receive lower quality matches to the requested vehicle slot. A lower quality match can include a vehicle slot at a different time, a vehicle slot to/from a different location, etc., optionally up to and including a complete denial of service.

Request arbitration model 508 can be configured to receive a number of context signals when processing the requests. The context signals can include any or all of first request context 514, second request context 520, and platform context data 526.

Request arbitration model 508 can process the requests in view of user account data. For instance, based on a user account status, allocations for journeys associated with that account can be a higher priority. By way of example, a user with a premium account, high-activity account, etc. can be afforded higher priority by the request arbitration model 508.

A positive preallocation balance can boost priority of a client system's requests. For instance, first transportation platform system 510 can be associated with a first service provider who has obtained a preallocated quantity of vehicle slots for servicing its requests. This can include, for example, an allocation per day, week, etc. While the first transportation platform system 510 is associated with a positive balance of preallocated vehicle slots, requests from the first transportation platform system 510 can be given higher priority as compared to an otherwise equivalent request from another system.

A positive preallocation balance can be one of a plurality of signals to the request arbitration model 508. For instance, even when first transportation platform system 510 may have a positive preallocation balance, request arbitration model 508 can reduce the priority of a request from first transportation platform system 510 in favor of another request from second transportation platform system 516 to increase overall ecosystem performance. For instance, satisfying a particular request from first transportation platform system 510 might involve initiating an almost empty flight to a remote destination, whereas satisfying a different, competing request from second transportation platform system 516 might involve initiating a full flight to a highly trafficked destination. HTP system 500 can compute a likelihood that the preallocation quantity will be satisfied even if the particular request is denied. Request arbitration model 508 can thus prioritize the request from the second transportation platform system 516 without violating the preallocation quantity to the first transportation platform 510.

In an example, the preallocated vehicle slots may be associated with a type of transportation service. The request arbitration model 508 may prioritize a request based on the type of transportation service. For example, the first transportation platform 510 may offer a shuttle service for workers to commute to an office or to otherwise transport employees. The first transportation platform 510 may have reserved the preallocated vehicle slots for this shuttle service. The second transportation platform 516 may offer on-demand ridesharing services. The request arbitration model 508 may prioritize allocation of vehicle slots to first transportation platform 510 given that the vehicle slots are to be used for commuter services, rather than on-demand transportation services.

Request arbitration model 508 can process requests in view of host system objectives. Host system objectives can include improving performance/efficiency of host resources such as host computing systems, host-operated vehicles, etc. For instance, request arbitration model 508 can prioritize allocation of vehicle slots along high-traffic routes (e.g., initializing additional flights by allocating the first slot of a plurality of slots on a flight to a particular destination) over low-traffic routes to less popular locations. This can increase efficiency by avoiding low-occupancy flights that have an increased risk of an empty leg on return.

An objective can be a global objective across a fleet of vehicles. A global objective can be a network-level goal for improving the performance of the transportation services, including the performance of services across multiple operational periods. This can include having a target distribution of aircraft at a set point in time. For example, an objective can include the ultimate location of vehicles in a fleet of vehicles (e.g., at certain aerial facilities at the end of day). The ultimate location can be an end-of-shift terminus location where maintenance can be performed or a desired departure location for a future journey leg. This objective can be facilitated by request arbitration model 508 by prioritizing requests that align with the desired movement of the fleet. By way of example, a vehicle slot on a new flight may be more likely to be allocated for a request that would take the assigned aircraft to a location at which the aircraft could receive maintenance, charging, etc. at the end of the day.

In some implementations, a global objective can include an occupancy rate for the one or more aircraft flights. For example, the objective can include achieving the highest possible occupancy of flights within an operational time period (e.g., a day) across a plurality of flights.

In another example, the object can include improving an occupancy rate for a subsequent flight after servicing at a request. For example, allocating a vehicle slot to a first request can include the creation of a new flight to a destination aerial facility for the associated user. The request arbitration model 508 may determine that the aircraft for the new flight would have a subsequent flight from the destination aerial facility that may be fulfilled given the demand at the according time of day.

Request arbitration model 508 can leverage forecasted transportation demands to increase fleet efficiency. This can include an increase in energy efficiency, realization rates, etc. A forecasted high demand associated with a requested destination can increase the priority of requests for transport to a destination, at least as compared to requests for transport to a different destination that is associated with a forecasted low demand. The forecasted low demand can represent, for example, a low likelihood of future trips departing from the destination. Accordingly, request arbitration model 508 can increase the utilization rate of the fleet and an improved user experience by prioritizing the movement of a supply of vehicles toward high demand areas.

Request arbitration model 508 can resolve conflicting requests via real-time auction. For instance, HTP system 500 can publish data describing one or more vehicle slots that are available. First transportation platform system 510 and second transportation platform system 516 can submit, to HTP system 500, first slot request 512 and second slot request 518 for a particular vehicle slot. First transportation platform system 510 and second transportation platform system 516 can submit, to HTP system 500, respective transaction values associated with first slot request 512 and second slot request 518. The transaction values can be context signals to HTP system 500 for holistically processing the requests to compute prioritization, or the transaction values can be a signal that determines prioritization for a requested vehicle slot. The transaction value can include, for example, a bid with a specified currency such as US Dollars, etc.

Real-time data can be collected for use by request arbitration model 508. Any of the data described herein for use by request arbitration model 508 can be collected in real-time to reflect a current state. Request arbitration modal 508 can utilize such data to help compute the priorities for the respective requests.

The data ingested by request arbitration model can include real-time data associated with a user 110. By way of example, request arbitration model 508 can utilize data indicative of the current location of the user 110 as well as real-time traffic information that may impact the accuracy of the estimated time of arrival of the user 110 at an aerial facility. In some implementations, request arbitration model 508 may take into account real-time location data of other users such as, for example, the users that are already assigned to a particular flight. This real-time location data may indicate that a particular flight is likely to already experience a delay given the location of other users relative to an aerial facility. As such, a request with time constraints that do not align with the originally scheduled departure may not be de-prioritized to the same extent.

In some implementations, the data ingested by request arbitration model 508 can include real-time performance data. Real-time performance data can include data associated with the ongoing performance of the multimodal transportation services as well as the resources used for providing such services. This can include real-time data indicative of the current progress/timeliness of flights, current charging resources being utilized, current charging needs of aircraft, current landing pads or parking areas being utilized, etc. In some implementations, real-time performance data can be indicative of the performance of service providers, such as ground vehicle service providers. Such information can include real-time ratings, feedback, and arrival statistics that reflect how a certain service provider is currently performing. Request arbitration modal 508 can utilize such data to help compute the priorities for the respective requests.

By way of example, request arbitration model 508 can be configured to ingest data indicating the real-time charging needs of several aircraft. This charging information may be different than that originally used to develop an initial schedule of the aircraft because, for example, several aircraft may have needed to utilize extra power for propulsion during a stronger-than-expected head wind. As such, it may be prudent to avoid adding another passenger to an aircraft such that it can maintain a lower payload and, thus, use less battery charge on a subsequent flight. This can help the aircraft stay on schedule for the subsequent flight by avoiding increased charging time. Accordingly, request arbitration model 508 may compute a lower priority for a vehicle slot request for the subsequent flight since adding another passenger may result in delays or decreased aircraft performance.

In some implementations, request arbitration model 508 can ingest real-time data associated with one or more third-party computing systems. By way of example, real-time weather data, noise data, or other airspace system data 318 or third-party provider system data 320. Request arbitration modal 508 can utilize such data to help compute the priorities for the respective requests.

By way of example, real-time noise data can be collected via sensors located at an aerial facility, onboard aircraft, or by third-party systems. The noise data may indicate that the current noise levels in the area may result in re-routing of certain aircraft. The new routes may increase the flight durations for certain flights. This may result in an adjustment to take-off time or an adjustment in the arrival time. As such, request arbitration model 508 may deprioritize a vehicle slot request for which the new time constraints of the flight misalign with those of the vehicle slot request. Moreover, request arbitration model 508 may deprioritize a vehicle slot request in the event that forgoing the addition of another passenger may help the aircraft more quickly traverse its new route.

Based on a prioritization obtained using request arbitration model 508, HTP system 500 can generate responses to the requests. First response 522, if prioritized over second response 524, can communicate allocation of a vehicle slot that provides a closer match to the criteria of first slot request 512 as compared to an allocation communicated in second response 524. First response 522 can be a positive response, and second response 524 can be a negative response. Second response 524 can provide a null allocation, or an allocation of no vehicle slot. First response 522 or second response 524 can communicate one or more candidate alternatives to the requested vehicle slot. The candidate alternatives can be identified by relaxing the constraints in the request. The relaxed constraints can include a time shift, a departure location shift, an arrival location shift, or a trip type shift. The trip type shift may include, for example, shifting from an individual ride to a pooled ride, shifting a type of vehicle, shifting a type of seat class or seat location (e.g., from a window seat), or changing another type of condition of the trip.

The constraints can be relaxed within specified bounds (e.g., relax departure time by no more than 15 minutes, etc.). If no vehicle slots match the requirements of the request, even when relaxed, a null allocation can be returned.

The responses can be issued at the same time or at different times. For instance, first response 522 can be output first, containing a prioritized response communicating a more favorable allocation. The more favorable allocation can indicate that vehicle slot is available to the requesting platform, if desired. The second response 524 can be paused for a set interval to determine whether the allocation of the first response 522 will be accepted or rejected. If the first response 522 is not accepted or is rejected, the second response 524 can contain the more favorable allocation from the first response 522 (e.g., indicating that the vehicle slot is available).

The responses can contain various types of information. For example, first response 522 can communicate allocation of a vehicle slot. Additionally, first response 522 or second response 524 can communicate a full multi-leg multimodal itinerary in which an allocated vehicle slot provides at least one leg of the journey.

Although FIG. 5 contains an illustration of a first request 512 and a second request 518, it is to be understood that a plurality of conflicting and non-conflicting requests can be submitted to HTP system 500. Request arbitration model 508 can prioritize the respective responses to the plurality of requests. HTP system 500 can generate a plurality of allocation matches corresponding to the plurality of requests, with one or more allocations conforming to the constraints in the corresponding requests and with one or more allocations partially or approximately conforming to the constraints in the corresponding requests (or relaxed constraints based thereon). The allocations can be ranked in order of match quality or accuracy and returned responsive to the plurality of requests in order of priority, such that the higher priority requests receive higher quality allocation matches while the lower priority requests receive the lower quality allocation matches, or even a null allocation whereby no vehicle slot is allocated.

In some implementations, the request arbitration model can prioritize slot requests based on the likelihood that an associated user will be able to return from a destination location. For example, first slot request 512 can be associated with a flight to aerial facility X, located within an office park. Thus, it may be likely that a user will need a return flight, the lack of which would harm the user's experience with the transportation service. The request arbitration model 508 can compute a score including, for example, a percentage, level, etc. indicating the likelihood that a user will request, and be able to receive, a vehicle slot on a return flight from aerial facility X.

The likelihood of the return flight can be computed based on historical data indicating the historic demand, supply, and utilization for aerial transport from aerial facility X. The historical data can be structured according to dates, days of the week, times, etc. The request arbitration model 508 can use this data to help determine whether sufficient demand and aircraft supply will exist at a later time such that a return flight (with sufficiently filled vehicle slots) may, or should, be available for the user. In some implementations, the need for a return flight may be indicated by the user when requesting or booking a multimodal transportation service through a software application. The higher the likelihood a subsequent flight will be available (or should be made available), the lower the risk of the user being unable to obtain a return flight. This can result in a higher score for the first slot request 512 since it is less likely to lead to a poor user experience.

The second slot request 518 can be associated with a flight to aerial facility Y, whereby the user will need a return flight. The request arbitration model 508 can compute a low likelihood that a return flight will be available for a user associated with second slot request 518. Accordingly, the request arbitration model 508 can allocate a vehicle slot for the first slot request 512 over the second slot request 518.

In some implementations, host transportation platform system 500 can field requests from internal and external client systems. As described herein, the host transportation platform 500 can include an internal client system operated by the same or related entity as the service provider entity providing the requested transportation service (and associated with the host transportation platform 500). External clients can be associated with other service provider entities.

By way of example, first transportation platform system 510 may be an internal client system of host transportation platform 510. First transportation platform system 510 may be configured to coordinate transportation for a fleet of ground vehicles owned, operated, lease, managed, etc. by the same entity that is associated with host transportation platform system 500, which coordinates transportation for an aircraft fleet of that entity. Second transportation platform system 516 may be an external client system associated with a ground transportation service provider that is different than the entity associated with host transportation platform 500.

Internal client systems such as first transportation platform system 510 can be assigned a prioritized status as compared to one or more external client systems such as second transportation platform system 516. Thus, requests from internal clients can receive more favorable allocations of resources than such external client systems. Internal client systems, and their requests, can be assigned a prioritized status as compared to one or more external client systems. Thus, requests from such one or more external client systems can be assigned a lower prioritized status as compared to the internal client systems.

### Example Computer-Implemented Methods and Processes

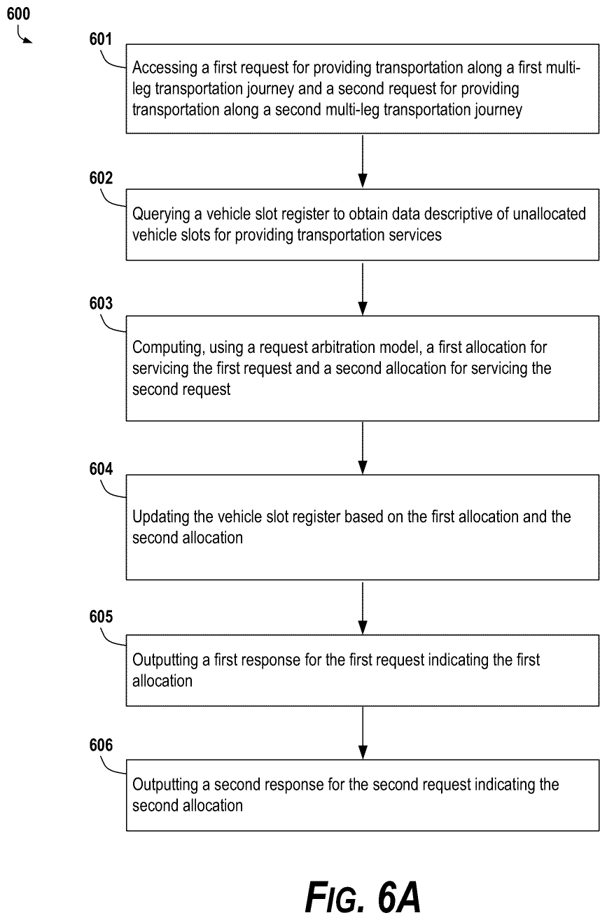

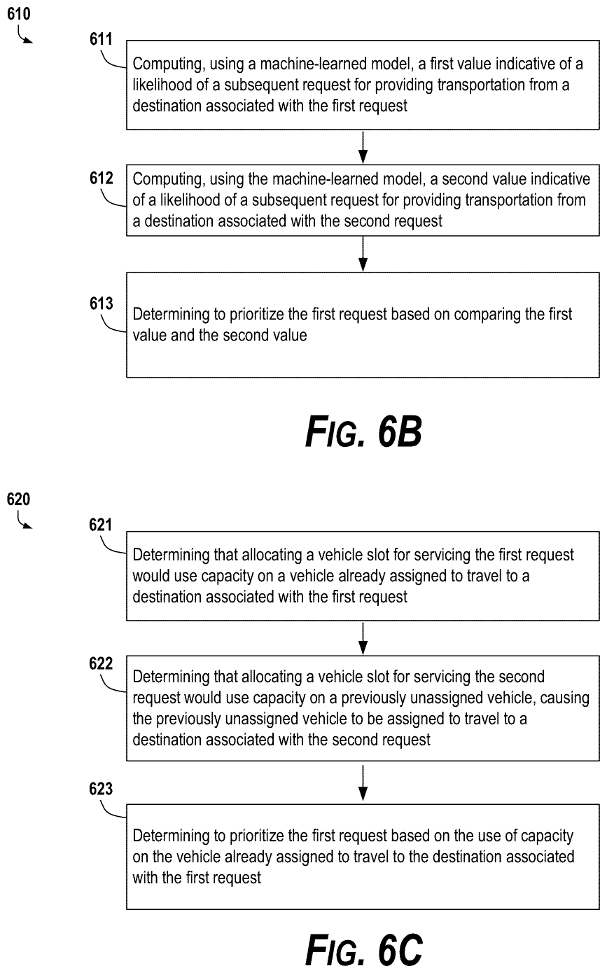

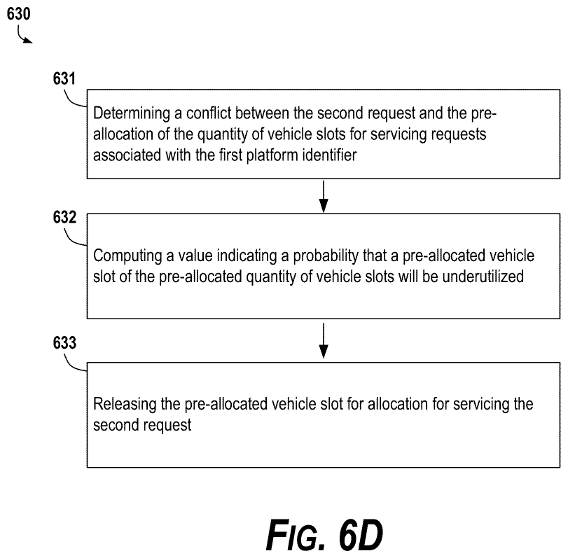

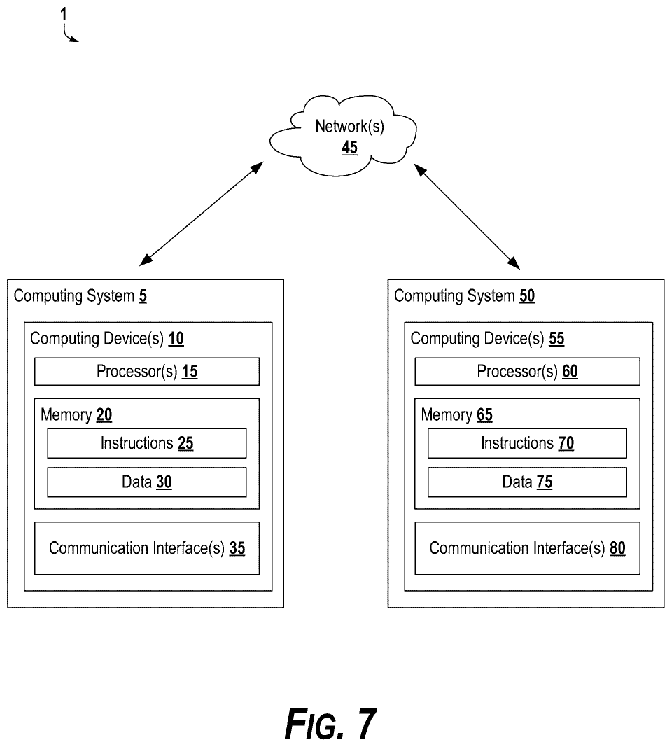

FIG. 6A depicts a flowchart diagram of an example method 600 for coordinating vehicle slot requests according to example embodiments of the present disclosure. The method 600 can be performed by a computing system that includes one or more computing devices such as, for example, the computing systems described with reference to the other figures. Each respective portion of the method 600 can be performed by any (or any combination) of one or more computing devices. Moreover, one or more portion of the method 600 can be implemented as an algorithm on the hardware components of the devices described herein (e.g., as in FIGS. 1-5, 7, etc.).

FIG. 6A depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6A is described with reference to elements/terms described with respect to other systems and figures for example illustrated purposes and is not meant to be limiting. One or more portions of method 600 can be performed additionally, or alternatively, by other systems.

At 601, example method 600 can include accessing (e.g., using a HTP system 500) a first request for providing transportation along a first multi-leg transportation journey and a second request for providing transportation along a second multi-leg transportation journey. In some implementations of example method 600, the first request and the second request can present conflicting constraints for service. For instance, the first request can be a first slot request 512 from first transportation platform system 510 requesting a seat on a flight. The second request can be a second slot request 518 from second transportation platform system 516 requesting a seat on a flight. As described herein, the second slot request 518 can be in conflict with the first slot request 512 because, for example, it requests the one or more same or overlapping slots (e.g., the same seat). The method 600 can be performed to compute the allocation for these requests to resolve the conflict.

In some implementations of example method 600, a transportation platform associated with the first request can be different than a transportation platform associated with the second request. For example, the first request can be from a first transportation platform computing system associated with a first platform identifier and the second request can be from a second transportation platform computing system associated with a second platform identifier. The first platform identifier can represent a service provider (or a computing system associated therewith) that is different from the second platform identifier, which represents another service provider (or computing system associated therewith).

At 602, example method 600 can include querying a vehicle slot register (e.g., slot register 502) to access data descriptive of unallocated vehicle slots for providing transportation services. As described herein, the vehicle slots can correspond to seats on one or more aircraft flights.

Querying the vehicle slot register may include querying one or more back-end services. As described herein, an API gateway may process a request to determine which services to call in order to appropriately respond to the request. This may include calling a service that maintains the vehicle slot register. This may also include calling services to access other data that may be input into the request arbitration model. This may include, for example, calling services that manage flight schedules, routes, user information (e.g., ratings, usage frequency, etc.), information about other service providers (e.g., ratings, ETA accuracy, frequency of use, etc.), or other services.

At 603, example method 600 can include computing, using a request arbitration model, a first allocation for servicing the first request and a second allocation for servicing the second request. In some implementations of example method 600, the first allocation can satisfy the constraints of the first request. In some implementations of example method 600, the first allocation can include an allocated vehicle slot for servicing the first request according to one or more constraints in the first request. This can include, for example, allocating vehicle seats for the first request that align the time, location, number, etc. parameters included in the first request.

In some implementations of example method 600, the second allocation can include one or more candidate alternatives to one or more constraints in the second request. For example, the second allocation can include an allocated vehicle slot for servicing the second request according to one or more relaxed constraints. As described herein, the one or more relaxed constraints can include a time shift, a departure location shift, an arrival location shift, or a trip type shift.

In some implementations of example method 600, a quantity of vehicle slots can be pre-allocated for servicing requests associated with a platform identifier. For example, the first can include a first platform identifier. The HTP system 500 can utilize the first platform identifier to perform a look-up, service call, or other database search function to compute the number of pre-allocated quantity of vehicle slots associated with the first platform identifier. In some implementations of example method 600, the first allocation can be allocated from this pre-allocated quantity of vehicle slots.

In some implementations of example method 600, example method 600 can include determining a conflict between the second request and the pre-allocation of the quantity of vehicle slots for servicing requests associated with the first platform identifier. For example, method 600 can include computing a probability that a pre-allocated vehicle slot of the pre-allocated quantity of vehicle slots will be underutilized. In some implementations, the probability that a pre-allocated vehicle slot will be used may be above a certain threshold (e.g., 50%, 75%, 90%, etc.). In an example, the probability can be computed based on the historical usage/acceptance rate of the requesting service provider. Such information may be stored in association with a platform identifier of the service provider, which may be referenced when accessing such data via a back-end service. The historical usage/acceptance rate may indicate that a first service provider associated with the first request historically utilized 97% of its pre-allocated slots.

In the event that the probability that a pre-allocated vehicle slot will be used is below a certain threshold, the example method 600 can include releasing the pre-allocated vehicle slot for allocation for servicing the second request. This may occur, for example, in the event the historical usage/acceptance rate indicates that the first service provider associated with the first request historically utilized 49% of its pre-allocated slots.

In some implementations of example method 600, the request arbitration model can be configured to receive request data and generate a score for a corresponding request. In some implementations of example method 600, example method 600 can include computing, based on a score for the first request and a score for the second request, the first allocation for servicing the first request.

In some implementations of example method 600, the request arbitration model can be configured to generate the score for the corresponding request based on at least one of the following features: a platform identifier associated with the corresponding request, user data associated with the corresponding request, forecasted utilization of available vehicle slots, departure location data associated with the corresponding request, arrival location data associated with the corresponding request, or scheduling data associated with the corresponding request. Such data can be collected as real-time data for use by the request arbitration model. The score can include a number, level (e.g., low, medium, high), percentage, character grade, etc. that is indicative of the potential value of the request.

For instance, one or more of the features can be input to the request arbitration model. The request arbitration model can use the platform identifier associated with the corresponding request to retrieve performance metrics for a transportation platform/service provider submitting the request. As described herein, the performance metrics can be indicative of a realization rate of requests. This information can be used by the request arbitration model to forecast utilization of available vehicle slots. For example, a higher historical realization rate for a particular service provider can lead to a higher forecasted utilization rate, indicating the service provider will likely use the vehicle slot if allocated to the request. The higher forecasted utilization rate can increase the score computed by the request arbitration model.

Additionally, or alternatively, the request arbitration model can use the platform identifier associated with the corresponding request to retrieve quality measurements for a transportation platform/service provider submitting the request. As described herein, quality measurements can be indicative of, for example, quality scores or values representative of user/rider feedback that describes the quality of the experience with the associated service provider. The higher quality measurements can increase the score computed by the request arbitration model because, for example, a request that is likely to yield a positive/high quality experience for a rider can be considered of higher overall value. In this way, the request arbitration model can be configured to generate the score for the corresponding request based on the historical platform performance data associated with the platform identifier that was transmitted in the corresponding request.

The request arbitration model can be configured to generate the score based on the origin associated with the request, the destination associated with the request, or scheduling data associated with the corresponding request. For instance, for origin or destination locations that correspond to aerial facilities with high levels of traffic/demand, the score can be higher because it may be more likely that a vehicle slot will be available on a current flight or made available on a new flight that is more likely to be filled. In the event that the origin or destination locations correspond to aerial facilities with lower levels of traffic/demand, this can down weight, or weigh against, the score because it may be less likely that a vehicle slot will be available on a current flight or because the creation of a new flight to accommodate the requested vehicle slot would result in a flight that is less likely to be filled (e.g., above a certain number of passengers threshold).

Additionally, or alternatively, the request arbitration model can be configured to generate the score based on the scheduling data associated with the corresponding request. For example, based on a current schedule of flights, the request arbitration model can determine whether allocation of the vehicle slot for the request would result in a delay of an associated flight due to an ETA of the assigned passenger from an origin location that is far from the departure aerial facility. Such a circumstance can negatively affect the score.

In some implementations, the request arbitration model can process user data associated with the corresponding request to retrieve user account data and historical use data associated with the request. This type of information can be utilized to compute a score for the vehicle slot request. For instance, a user with a higher frequency of use of aerial transportation may result in a higher score because the user is more likely to accept/utilize the flight associated with the requested vehicle slot than others with a lower frequency of use. Moreover, the user may also be more likely to use aerial transportation in future instances.

The request arbitration model can generate one or more outputs for prioritizing the received requests. The outputs can include the scores, or other values, computed by the request arbitration model. The HTP system can use the scores or values to rank the requests. In some implementations, the outputs can include the ranking itself.

The prioritization can be based on a host objective. In some implementations of example method 600, the request arbitration model can be configured to compute the score for the corresponding request based on a host objective for the vehicle slots. For example, a host objective can include increasing an occupancy rate for the one or more aircraft flights. In some implementations of example method 600, a host objective can include increasing an occupancy rate for a subsequent flight after servicing at least one of the first request or the second request. In some implementations of example method 600, a host objective can include a target distribution of aircraft at a set point in time.

In some implementations, the request arbitration model can use a forecasted utilization of available vehicle slots to understand downstream ecosystem effects of prioritizing one request over another. Downstream ecosystem effects can include the locations of resources, such as aircraft, operators, operator devices, etc. Downstream ecosystem effects can include utilization of facilities, such as occupation of landing pads, hangars, etc.

The request arbitration model can use departure location data associated with the corresponding request, arrival location data associated with the corresponding request, or scheduling data associated with the corresponding request. This data can be used to evaluate the conflict among requests as well as evaluate relative impacts on the ecosystem resources between the conflicting requests to improve overall ecosystem performance. The request arbitration model can utilize such data to determine whether overall ecosystem performance is positively or negatively impacted by selecting one request over another.

By way of example, overall ecosystem performance can be considered to be negatively impacted in the event that selecting a first request over a conflicting request would result in a delay of one or more flights, flight deadheading, overcrowding of aerial facilities, etc.

In another example, overall ecosystem performance can be considered to be positively impacted in the event that selecting a first request over a conflicting request would not result in a delay of one or more flights, flight deadheading, overcrowding of aerial facilities, etc. or would resolve or avoid these types of issues.

In some implementations of example method 600, the request arbitration model can be configured to prioritize allocation of vehicle slots on high-traffic routes. For example, high-traffic routes can be associated with high rates of resource utilization, providing for efficient operation, such as by regularly operating aircraft at capacity. Thus, prioritizing allocation of vehicle slots along high-traffic routes can result in future availability of the vehicle slots along the high-traffic route, such that it is more likely that vehicle slots are to be utilized.

In some implementations of example method 600, the request arbitration model can include a machine-learned model trained to generate scores based on request data for the corresponding request. An example implementation using a machine-learned models is described in more detail with reference to FIGS. 5A and 6B.

The allocation of vehicle slots for servicing the first request or the second request can be based on real-time data. This can allow the request arbitration model to compute priorities for allocating vehicle slots based on up-to-date information that reflects the current state of the transportation network. Using real-time data as described herein, can provide a particular technological advantage because it allows the request arbitration model to compute priorities and determine allocations more accurately when addressing on-demand requests for platform resources during the current operational day, rather than for scheduling at some future date. The real-time data can include be associated with a user or include real-time performance data collected by the systems described herein. This can include, for example, real-time location data of users or vehicles, real-time data describing the charging levels/needs of aircraft, real-time data describing facility usage (e.g., occupancy of landing, parking, charging, take-off areas), real-time weather data, real-time traffic data, real-time noise date, real-time feedback data (e.g., from passengers, vehicle operators), or other types of data. This type of information can be made available to the request arbitration model through one or more backend services. The request arbitration model can utilize such information when prioritizing requests.

The computing system can access real-time data associated with a first user for the first request and real-time data associated with a second user of the second request. By way of example, the computing system can access real-time data associated with the first user that indicates a current location of the first user at origin A. The computing system can access real-time data associated with the second user that indicates a current location of the second user at origin B. Such data may initially be provided by the client systems submitting the first and second requests. The computing system can also access real-time data that indicates the respective location of other users that are already assigned to the flight for which the first and second request are requesting vehicle slots.

The computing system can access real-time performance data associated with the transportation services. The real-time performance data can be indicative of the current performance of an aircraft for which the first and second requests are requesting vehicle slots. The real-time performance data can indicate the location of the aircraft, the current charging level of the aircraft, and the status of the aircraft relative to its originally planned ETAs. The computing system can access real-time traffic data that indicates the respective traffic levels between the aerial facility and the origins A and B.

The computing system can compute, using the request arbitration model, the first allocation for servicing the first request and the second allocation for servicing the second request based on the real-time data associated with the first user, the real-time data associated with the second user, and the real-time performance data associated with the transportation services. For instance, the real-time performance data can indicate that the aircraft will need to charge longer than expected before its next flight, shifting the take-off time by a few minutes. The real-time data can also indicate that multiple users that are already assigned to the next flight are delayed and will arrive at the aerial facility later than expected. As such, the take-off time for the next flight can be shifted back to accommodate the aircraft charging and the already assigned users.

This information can be utilized by the request arbitration model when evaluating the first request and the second request. For example, the request arbitration model may determine that the ETA of the first user (travelling from origin A under current traffic conditions) will cause the first user to arrive at the aerial facility much earlier than required given the current delay of the flight. The request arbitration model may determine that the ETA of the second user (from origin B under the current traffic conditions) will have the second user arrive at the aerial facility later than the first user, but at a more appropriate time for the requested flight. Thus, the request arbitration model may compute a higher priority for the second request than the first request, allocating the vehicle slot to the second request. The first request can be provided with an alternative allocation, such as a seat on an earlier flight or a newly created flight.

At 604, example method 600 can include updating the vehicle slot register based on the first allocation and the second allocation. For instance, the vehicle slot register can be updated to reflect the status of the vehicle slots as allocated, including a type of allocation associated with the vehicle slots. In some implementations of example method 600, updating the vehicle slot register based on the first allocation and the second allocation can include respectively updating an availability for the allocated vehicle slots to indicate a reservation on the allocated vehicle slots. In some implementations of example method 600, updating the vehicle slot register based on the first allocation and the second allocation can include initiating an expiration interval for the allocated vehicle slots, and the expiration interval can be configured to trigger expiry of the reservation, reverting the availability for the allocated vehicle slots.

At 605, example method 600 can include outputting a first response for the first request indicating the first allocation. This can include providing the first response to the requesting computing platform via the communication channel established between the HTP system and the requesting computing platform. The response can be formulated according to an API gateway that called one or more back-ends services for a responding to the submitted request.

At 606, example method 600 can include outputting a second response for the second request indicating the second allocation. This can include providing the second response to the computing platform that transmitted the second request, via the communication channel established between the HTP system and that computing platform. In some implementations of example method 600, the second allocation can be a null allocation (e.g., a denial of request for an allocation).

The prioritization can be organic based on contextual signals available to the request arbitration model. For instance, the request arbitration model can determine the prioritization of conflicting requests independently of feedback from the requesting systems.

The prioritization can be determined cooperatively or iteratively with the requesting systems. For instance, the prioritization can be auctioned, as described herein. To implement the auction, example method 600 can include receiving, for the first request and from a first transportation platform computing system, a first transaction value (e.g., in terms of currency, cost savings, etc.). Example method 600 can include receiving, for the second request and from a second transportation platform computing system, a second transaction value. Example method 600 can include assigning, based on a comparison of the first transaction value and the second transaction value, the prioritized allocation for servicing the first request in the event, for example, the first transaction value is higher than the second transaction value (e.g., in terms of monetary value, costs saved, etc.).

FIG. 6B depicts a flowchart diagram of an example method 610 for coordinating vehicle slot requests according to example embodiments of the present disclosure. The method 610 can be performed by a computing system that includes one or more computing devices such as, for example, the computing systems described with reference to the other figures. Each respective portion of the method 610 can be performed by any (or any combination) of one or more computing devices. Moreover, one or more portion of the method 610 can be implemented as an algorithm on the hardware components of the devices described herein (e.g., as in FIGS. 1-5A, 7, etc.).

FIG. 6B depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6B is described with reference to elements/terms described with respect to other systems and figures for example illustrated purposes and is not meant to be limiting. One or more portions of method 610 can be performed additionally, or alternatively, by other systems.

Example method 610 can include any portion or all of example method 600.

At 611, example method 610 can include computing, using a machine-learned model, a first value indicative of a likelihood of a subsequent request for providing transportation from a destination associated with the first request. Request arbitration model 508 can include the machine-learned model for forecasting future demand on the vehicle slots. Such model can be helpful when prioritizing conflicting vehicle slot requests.

For example, a vehicle slot request can be associated with a flight to aerial facility A. This may result in the creation of a new flight or the redirection of an aircraft to aerial facility A. The first value can be computed, by the machine-learned model, to help indicate whether a potential subsequent flights of that aircraft (e.g., a return light) will be full or result in deadheading.

At 612, example method 610 can include computing, using the machine-learned model, a second value indicative of a likelihood of a subsequent request for providing transportation from a destination associated with the second request. For example, the destination can be aerial facility B. The second value can be, for example, a percentage, level, etc. indicating the likelihood that a user will request (and utilize) a vehicle slot on a return flight, or other subsequent flight, on the aircraft from aerial facility B. The second request may conflict with the first request because there are not enough aircraft, facility, or operator resources for both flights.

The first value and the second value can be generated by the machine-learned model based on one or more inputs to the model. For instance, the machine-learned model can receive as inputs request data and request context for each request. The machine-learned model can receive as input platform context data. The machine-learned model can tokenize or otherwise embed the inputs, or portions thereof, for processing by the machine-learned model. The machine-learned model can process the inputs to compute one or more outputs. The machine-learned model can provide a classification output, such as “approve” and “deny.” The machine-learned model can provide a regression output, such as a value or score. The machine-learned model can output a score for a given request. The score can be absolute or relative, such as relative to one or more other requests. The score can be used to prioritize responses to the various requests.

The machine-learned model can provide a value corresponding to a likelihood. For instance, the machine-learned model can be or include a forecasting model. A forecasting model can be trained to forecast data. A forecasting model can be trained to forecast demands on a transportation platform by feeding the model data describing a current state of the transportation platform and using a feedback loop to update the model based on a comparison of its forecast demands with the actual demands. For instance, the forecasting model can be updated by backpropagating a loss through the model, where the loss is based on a comparison of its forecast demands with the actual demands. One or more parameters of the forecasting model can be updated to reduce the loss.

The first value and the second value can be intermediate outputs of the machine-learned model. For instance, an output of a forecasting model that provides the first value and the second value can be passed to another portion of the machine-learned model for further processing. For instance, another model component can receive the first value and the second value as context signals and output a prioritization. The model component can be a compare function.

At 613, example method 610 can include determining to prioritize the first request based on comparing the first value and the second value. For instance, request arbitration model 508 can compare forecasts of future demands at the locations associated with the vehicle slots and prioritize accordingly to increase utilization of the vehicle slots in the future.

For example, request arbitration model can process a first request for a vehicle slot from a departure location with a first destination location (e.g., aerial facility A) and a second request for a vehicle slot from the departure location with a second destination location (e.g., aerial facility B). The request arbitration model can determine that the requests conflict, such as by placing conflicting demands on an aerial facility resource, such as a takeoff area at the departure location.

The request arbitration model can compute, with the machine-learned model, a first value indicative of a likelihood of a subsequent request for providing transportation from the first destination location. As such, the first value can indicate a likelihood that the vehicle slot will be utilized at the first destination location, or inversely a likelihood that the vehicle slot will not be empty on the next flight. The request arbitration model can compute, with the machine-learned model, a second value indicative of a likelihood of a subsequent request for providing transportation from the second destination location. As such, the second value can indicate a likelihood that the vehicle slot will be utilized at the second destination location, or inversely a likelihood that the vehicle slot will not be empty on the next flight. The likelihood that the vehicle slot will be utilized at the first destination location can be higher than the likelihood of a subsequent request for providing transportation from the second destination location. As such, the request arbitration model can thus prioritize the first request to improve the efficiency of system resource utilization.

In some implementations of example method 600, the request arbitration model can be configured to deprioritize allocation of vehicle slots that trigger initialization of a new flight. For example, FIG. 6C depicts a flowchart diagram of an example method 620 for coordinating vehicle slot requests according to example embodiments of the present disclosure. The method 620 can be performed by a computing system that includes one or more computing devices such as, for example, the computing systems described with reference to the other figures. Each respective portion of the method 620 can be performed by any (or any combination) of one or more computing devices. Moreover, one or more portion of the method 620 can be implemented as an algorithm on the hardware components of the devices described herein (e.g., as in FIGS. 1-5, 7, etc.).

FIG. 6C depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6C is described with reference to elements/terms described with respect to other systems and figures for example illustrated purposes and is not meant to be limiting. One or more portions of method 620 can be performed additionally, or alternatively, by other systems.

Example method 620 can include any portion or all of example methods 600 or 610.

At 621, example method 620 can include determining that allocating a vehicle slot for servicing the first request would use capacity on a vehicle already assigned to travel to a destination associated with the first request. For example, a first aircraft can be assigned to travel to a first destination. The first aircraft can have one remaining seat. The first request can request one seat for transportation to the first destination at a first time.

At 622, example method 620 can include determining that allocating a vehicle slot for servicing the second request would use capacity on a previously unassigned vehicle, causing the previously unassigned vehicle to be assigned to travel to a destination associated with the second request. A second aircraft can be unassigned, such that there are no allocated vehicle slots on board the second aircraft.

In an example, the second request can include a request for two seats to travel to the first destination at the first time. Due to the timing, with both requests requesting travel at the same time, the first request and the second request can conflict due to a capacity of an arrival or departure area, a capacity of a flight path or region, availability of personnel to staff the same, etc.

For example, a departure location may have capacity for checking in only one more party prior to the first time, such as only being able to check in either the solo user associated with the first request or the party of two associated with the second request. Thus, the requests can conflict even if additional vehicles and slots are available. For instance, to service the second request at the same time, the second aircraft could be called into service. However, it may be undesirable to service the second request if only the two seats of the aircraft are utilized.

In another example, the first request and the second request can conflict due to a capacity of the first aircraft—the first aircraft lacks sufficient seating for two more riders. The second aircraft may have more seats than the first aircraft, such that the second aircraft could carry all the riders that were originally assigned to the first aircraft. But the second aircraft may also be less fuel or energy efficient, more costly to maintain, require additional pilots, etc. Or the second aircraft may be better suited for service of other itineraries, such as longer distance itineraries, and reassigning it to service the first request and the second request would disrupt the fleet organization for the other itineraries.

Accordingly, resolution of the conflict can include determining the higher priority use of the current resources in service. At 623, example method 620 can include determining to prioritize the first request based on the use of capacity on the vehicle already assigned to travel to the destination associated with the first request, thereby increasing the utilization of the current flight.

FIG. 6D depicts a flowchart diagram of an example method 630 for coordinating vehicle slot requests according to example embodiments of the present disclosure. The method 630 can be performed by a computing system that includes one or more computing devices such as, for example, the computing systems described with reference to the other figures. Each respective portion of the method 630 can be performed by any (or any combination) of one or more computing devices. Moreover, one or more portions of the method 630 can be implemented as an algorithm on the hardware components of the devices described herein (e.g., as in FIGS. 1-5, 7, etc.).

FIG. 6D depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure. FIG. 6D is described with reference to elements/terms described with respect to other systems and figures for example illustrated purposes and is not meant to be limiting. One or more portions of method 630 can be performed additionally, or alternatively, by other systems.

Example method 630 can include any portion or all of example methods 600, 610, or 620.

At 631, example method 630 can include determining a conflict between the second request and the pre-allocation of the quantity of vehicle slots for servicing requests associated with the first platform identifier. For instance, a first transportation platform that submits the first request can be assigned a quota of preallocated vehicle slots. For instance, the quota can guarantee that at least a minimum number of slots will be held out for use by the first transportation platform. At the time of the first request and the second request, the first transportation platform can have a positive balance of preallocated slots remaining. For instance, in the quota time period—for example, a day, if the quota is provided on a daily basis—there may be a remaining quantity of preallocated vehicle slots remaining to be allocated to servicing requests from the first transportation platform systems. For example, if the quota is one hundred slots per day, there may be thirty slots remaining in the quota for that day if seventy slots were allocated to the first transportation platform earlier that day. Thus, there may be a conflict between servicing the second request and satisfying the quota.

At 632, example method 630 can include computing a value indicative of a probability that a pre-allocated vehicle slot of the pre-allocated quantity of vehicle slots will be underutilized. For example, if the first transportation platform routinely does not submit more than one hundred slot requests, then it may be undesirable to deny the first slot request, as the denial may violate the quota of at least one hundred slots held out for use by the first transportation platform. However, if the first transportation platform routinely submits more than one hundred slot requests, then it may be likely that the first slot request can be denied or otherwise deprioritized without any impact on the guaranteed minimum, as the first transportation platform will, by the end of the day, likely have requested—and received—at least the minimum of one hundred slots.

At 633, example method 630 can include releasing the pre-allocated vehicle slot for allocation for servicing the second request. For instance, based on the determined value, the vehicle slot may be able to be released without jeopardizing the guarantee to the first transportation platform.

FIG. 7 depicts example system components of an example system 1 according to example implementations of the present disclosure. The example system 1 can include the computing system 5 and the computing system 50 that are communicatively coupled over one or more networks 45.

The computing system 5 can include one or more computing devices 10. The computing devices 10 of the computing system 5 can include one or more processors 15 and a memory 20. The processors 15 can be any suitable processing device (e.g., a processor core, a microprocessor, an ASIC, a FPGA, a controller, a microcontroller, etc.) and can be one processor or a plurality of processors that are operatively connected. The memory 20 can include one or more non-transitory computer-readable storage media, such as RAM, ROM, EEPROM, EPROM, one or more memory devices, flash memory devices, etc., and combinations thereof.

The memory 20 can store information that can be accessed by the processors 15. For instance, the memory 20 (e.g., one or more non-transitory computer-readable storage mediums, memory devices) can include computer-readable instructions 25 that can be executed by the processors 15. The instructions 25 can be software written in any suitable programming language or can be implemented in hardware. Additionally, or alternatively, the instructions 25 can be executed in logically or virtually separate threads on processors 15.

For example, the memory 20 can store instructions 25 that when executed by the processors 15 cause the processors 15 to perform operations such as any of the operations and functions of any of the computing systems (e.g., ATP system 208, GTP system 204, third party provider system 306, airspace system 304, etc.) or computing devices (e.g., user devices 116, ground vehicle devices 206, aircraft devices 212, aerial facility devices 210, including facility operator user devices, etc.), as described herein.

The memory 20 can store data 30 that can be accessed (e.g., obtained, received, written, manipulated, created, or stored). The data 30 can include, for instance, historical requests, context data, or other data/information described herein. In some implementations, the computing devices 10 can access from or store data in one or more memory devices that are remote from the computing system 5 such as one or more memory devices of the computing system 50.

In some implementations, the computing devices 10 can store one or more models. The models can include one or more machine-learned models, as described herein. In some implementations, the machined-learned models can be trained, or re-trained, using computing devices 10. The machine-learned models can be trained using training data as described herein. In some implementations, the machined-learned models can be stored at another device (e.g., computing system 50) and can be transmitted, or otherwise accessed by the computing system 5.

The computing devices 10 can also include a communication interface 35 used to communicate with one or more other systems (e.g., computing system 50). The communication interface 35 can include any circuits, components, software, etc. for communicating via one or more networks (e.g., 45). In some implementations, the communication interface 35 can include for example, one or more of a communications controller, receiver, transceiver, transmitter, port, conductors, software or hardware for communicating data/information.

The computing system 50 can include one or more computing devices 55. The computing devices 55 can include one or more processors 60 and a memory 65. The one or more processors 60 can be any suitable processing device (e.g., a processor core, a microprocessor, an ASIC, a FPGA, a controller, a microcontroller, etc.) and can be one processor or a plurality of processors that are operatively connected. The memory 65 can include one or more non-transitory computer-readable storage media, such as RAM, ROM, EEPROM, EPROM, one or more memory devices, flash memory devices, etc., and combinations thereof.

The memory 65 can store information that can be accessed by the processors 60. For instance, the memory 65 (e.g., one or more non-transitory computer-readable storage mediums, memory devices) can store data 75 that can be accessed. The data 75 can include, for instance, historical request data, context data, or other data or information described herein. In some implementations, the computing system 50 can access data from one or more memory devices that are remote from the computing system 50.

The memory 65 can also store computer-readable instructions 70 that can be executed by the processors 60. The instructions 70 can be software written in any suitable programming language or can be implemented in hardware. Additionally, or alternatively, the instructions 70 can be executed in logically or virtually separate threads on processors 60. For example, the memory 65 can store instructions 70 that when executed by the processors 60 cause the processors 60 to perform any of the operations or functions described herein, including, for example, any of the operations and functions of any of the computing systems (e.g., ATP system 208, GTP system 204, third party provider system 306, airspace system 304, etc.) or computing devices (e.g., user devices 116, ground vehicle devices 206, aircraft devices 212, aerial facility devices 210, including facility operator user devices, etc.), as described herein.

In some implementations, the computing devices 50 can store one or more models. The models can include one or more machine-learned models, as described herein. In some implementations, the machined-learned models can be trained, or re-trained, using computing devices 50. The machine-learned models can be trained using training data as described herein. In some implementations, the machined-learned models can be stored at another device (e.g., computing system 5) and can be transmitted, or otherwise accessed by the computing system 50.

The computing devices 55 can also include a communication interface 80 used to communicate with one or more other systems. The communication interface 80 can include any circuits, components, software, etc. for communicating via one or more networks (e.g., 45). In some implementations, the communication interface 80 can include for example, one or more of a communications controller, receiver, transceiver, transmitter, port, conductors, software or hardware for communicating data/information.

The networks 45 can be any type of network or combination of networks that allows for communication between devices. In some implementations, the networks 45 can include one or more of a local area network, wide area network, the Internet, secure network, cellular network, mesh network, peer-to-peer communication link or some combination thereof and can include any number of wired or wireless links. Communication over the networks 45 can be accomplished, for instance, via a network interface using any type of protocol, protection scheme, encoding, format, packaging, etc.

FIG. 7 illustrates one example system that can be used to implement the present disclosure. Other computing systems can be used as well. Computing tasks discussed herein as being performed at one computing devices can instead be performed at another device, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

### Additional Disclosure

Aspects of the disclosure have been described in terms of illustrative implementations thereof. Numerous other implementations, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only. Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims, operations, or processes discussed herein can be adapted, rearranged, expanded, omitted, combined, or modified in various ways without deviating from the scope of the present disclosure. At times, elements can be listed in the specification or claims using a letter reference for exemplary illustrated purposes and is not meant to be limiting. Letter references, if used, do not imply a particular order of operations or a particular importance of the listed elements. For instance, letter identifiers such as (a), (b), (c), . . . , (i), (ii), (iii), . . . , etc. may be used to illustrate operations or different elements in a list. Such identifiers are provided for the ease of the reader and do not denote a particular order, importance, or priority of steps, operations, or elements. For instance, an operation illustrated by a list identifier of (a), (i), etc. can be performed before, after, or in parallel with another operation illustrated by a list identifier of (b), (ii), etc.

The technology of the present disclosure may include the collection of data associated with a user. Collected data may be anonymized, pseudonymized, encrypted, noised, securely stored, or otherwise protected. Such collection may occur in the event that the user authorizes such collection or expressly opts into such collection. Authorization may be provided by the user via explicit user input to a user interface. The user input may be provided in response to a prompt that expressly requests such authorization. A user may opt out of such data collection at any time.

What is claimed is:

1. A method for computing responses to transportation requests to efficiently deploy vehicle slots, the method comprising:
accessing a first request for providing transportation along a first multi-leg transportation journey and a second request for providing transportation along a second multi-leg transportation journey, wherein the first request comprises first request data and the second request comprises second request data;
querying, using the first request data and the second request data, a vehicle slot register to access data descriptive of unallocated vehicle slots for providing transportation services;
computing, using a request arbitration model and based on the first request data, the second request data, and the data descriptive of unallocated vehicle slots, a first allocation for servicing the first request and a second allocation for servicing the second request, wherein the first request is prioritized over the second request;
updating the vehicle slot register based on the first allocation and the second allocation;
outputting a first response for the first request indicating the first allocation; and
outputting a second response for the second request indicating the second allocation.

2. The method of claim 1, wherein the first request and the second request present conflicting constraints for service, and wherein the first allocation and the second allocation resolve the conflict.

3. The method of claim 1, wherein computing the first allocation for servicing the first request and the second allocation for servicing the second request comprises:
accessing real-time data associated with a first user for the first request, real-time data associated with a second user of the second request, and real-time performance data associated with the transportation services, and computing the first allocation for servicing the first request and the second allocation for servicing the second request is based also on the real-time data associated with the first user, the real-time data associated with the second user, and the real-time performance data associated with the transportation services.

4. The method of claim 1, wherein the second allocation comprises a null allocation.

5. The method of claim 1, comprising:
computing, using a machine-learned model, a first value indicative of a likelihood of a subsequent request for providing transportation from a destination associated with the first request;
computing, using the machine-learned model, a second value indicative of a likelihood of a subsequent request for providing transportation from a destination associated with the second request; and
determining to prioritize the first request based on comparing the first value and the second value.

6. The method of claim 1, comprising:
determining that allocating a vehicle slot for servicing the first request would use capacity on a vehicle already assigned to travel to a destination associated with the first request;
determining that allocating a vehicle slot for servicing the second request would use capacity on a previously unassigned vehicle, causing the previously unassigned vehicle to be assigned to travel to a destination associated with the second request; and
determining to prioritize the first request based on the use of capacity on the vehicle already assigned to travel to the destination associated with the first request.

7. The method of claim 2, wherein the first allocation satisfies the constraints of the first request, and wherein the second allocation comprises one or more candidate alternatives to one or more constraints in the second request.

8. The method of claim 1, wherein the first allocation comprises an allocated vehicle slot for servicing the first request according to one or more constraints in the first request.

9. The method of claim 1, wherein the second allocation comprises an allocated vehicle slot for servicing the second request according to one or more relaxed constraints.

10. The method of claim 1, wherein the one or more relaxed constraints comprise a time shift, a departure location shift, an arrival location shift, or a trip type shift.

11. The method of claim 1, wherein updating the vehicle slot register based on the first allocation and the second allocation comprises:
respectively updating an availability for the allocated vehicle slots to indicate that the first allocation comprises a pending allocation of one or more vehicle slots; and
initiating an expiration interval for the pending allocation, the expiration interval configured to trigger expiry of the pending allocation, reverting availability of the allocated vehicle slots.

12. The method of claim 1, wherein a transportation platform associated with the first request is different than a transportation platform associated with the second request.

13. The method of claim 1, wherein:
the first request is from a first transportation platform computing system associated with a first platform identifier and the second request is from a second transportation platform computing system associated with a second platform identifier;
a quantity of vehicle slots are pre-allocated for servicing requests associated with the first platform identifier; and
the first allocation is allocated from the pre-allocated quantity of vehicle slots.

14. The method of claim 13, comprising:
determining a conflict between the second request and the pre-allocation of the quantity of vehicle slots for servicing requests associated with the first platform identifier;
computing a value indicating a probability that a pre-allocated vehicle slot of the pre-allocated quantity of vehicle slots will be underutilized; and
releasing the pre-allocated vehicle slot for allocation for servicing the second request.

15. The method of claim 1, wherein the request arbitration model is configured to receive request data and generate a score for a corresponding request, and wherein the method comprises:
computing, based on a score for the first request and a score for the second request, the first allocation for servicing the first request.

16. The method of claim 15, wherein the request arbitration model is configured to generate the score for the corresponding request based on at least one of: a platform identifier associated with the corresponding request, user data associated with the corresponding request, forecasted utilization of available vehicle slots, departure location data associated with the corresponding request, arrival location data associated with the corresponding request, or scheduling data associated with the corresponding request.

17. The method of claim 16, wherein the request arbitration model is configured to generate the score for the corresponding request based on historical platform performance data associated with the platform identifier associated with the corresponding request.

18. The method of claim 17, comprising:
monitoring a performance of a multi-leg itinerary associated with the first allocation;
storing log data descriptive of the performance in association with a platform identifier of a transportation platform that received the first allocation; and
generating a quality measurement for the transportation platform based on the log data;
wherein the request arbitration model is configured to generate the score for the corresponding request based on the quality measurement.

19. One or more non-transitory computer-readable media storing instructions that are executable by one or more processors to cause a computing system to perform operations, the operations comprising:
accessing a first request for providing transportation along a first multi-leg transportation journey and a second request for providing transportation along a second multi-leg transportation journey, wherein the first request comprises first request data and the second request comprises second request data;
querying, using the first request data and the second request data, a vehicle slot register to access data descriptive of unallocated vehicle slots for providing transportation services;
computing, using a request arbitration model and based on the first request data, the second request data, and the data descriptive of unallocated vehicle slots, a first allocation for servicing the first request and a second allocation for servicing the second request, wherein the first request is prioritized over the second request;
updating the vehicle slot register based on the first allocation and the second allocation;
outputting a first response for the first request indicating the first allocation; and
outputting a second response for the second request indicating the second allocation.

20. A computing system, comprising:
one or more processors; and
one or more non-transitory computer-readable media storing instructions that are executable by the one or more processors to cause the computing system to perform operations, the operations comprising:
accessing a first request for providing transportation along a first multi-leg transportation journey and a second request for providing transportation along a second multi-leg transportation journey, wherein the first request comprises first request data and the second request comprises second request data;
querying, using the first request data and the second request data, a vehicle slot register to access data descriptive of unallocated vehicle slots for providing transportation services;
computing, using a request arbitration model and based on the first request data, the second request data, and the data descriptive of unallocated vehicle slots, a first allocation for servicing the first request and a second allocation for servicing the second request, wherein the first request is prioritized over the second request;
updating the vehicle slot register based on the first allocation and the second allocation;
outputting a first response for the first request indicating the first allocation; and
outputting a second response for the second request indicating the second allocation.
